(19) United States
(12) Patent Application Publication
(10) Pub. No.: US 2009/0244479 A1
(43) Pub. Date: Oct. 1, 2009

(54) TINTED SILICONE OPHTHALMIC DEVICES, PROCESSES AND POLYMERS USED IN THE PREPARATION OF SAME

(76) Inventors: Diana Zanini, Jacksonville, FL (US); Ryan David Palusak, Ponte Vedra, FL (US); Adam C. Reboul, Jacksonville, FL (US); Terry L. Spaulding, Jacksonville, FL (US); Frank F. Molock, JR., Orange Park, FL (US); Ture Kindt-Larsen, Holte (DK); Frederik R. Sleenstrup, Hillerod (DK)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 12/408,327

(22) Filed: Mar. 20, 2009

Related U.S. Application Data
(60) Provisional application No. 61/040,880, filed on Mar. 31, 2008.

(51) Int. Cl. G02C 7/04; B05D 5/06; G02B 1/04

(52) U.S. Cl. 351/162; 427/164; 523/106; 523/108; 523/107

(57) ABSTRACT

Tinted ophthalmic devices, methods for their production, and non-crosslinked binding polymers used in their production are disclosed herein.

### RELATED APPLICATIONS

This application claims priority from U.S. provisional application Ser. No. 61/040,880, which is incorporated by reference in its entirety.

### FIELD OF THE INVENTION

This invention relates to tinted ophthalmic devices, in particular the use non-crosslinked polymers to prepare such ophthalmic devices.

### BACKGROUND

The use of tinted hydrogel contact lenses to alter the natural color of the iris is known. Generally, the tinted portion of the lens is located in the center of the lens, the portion of the lens that will overlay either or both the pupil and iris of the lens wearer. It is also known in the tinting of hydrogel contact lenses that the entire lens may be lightly tinted as a visibility or locator tint. See, U.S. patent application Ser. Nos. 10/027,579 and 11/102, 320, entitled COLORANTS FOR USE IN TINTED CONTACT LENSES AND METHODS OF THEIR PRODUCTION, AND PHOTOCHROMIC CONTACT LENSES AND METHODS FOR THEIR PRODUCTION, respectively, which are hereby incorporated by reference in their entirety.

Colorant compositions used to produce tinted hydrogel contact lenses are generally composed of a binding polymer, solvents, and pigments. Some colorants require the use of crosslinking agents to form covalent bonds between the lens materials and the binding polymer in order to form tinted lenses whose tints do not bleed or leach out. Additionally, in some methods for forming tinted lenses require that the lens body be formed prior to the introduction of the colorant onto the lens. Other processes and colorants require multiple steps for use alone or in conjunction with specialized rings to protect the outer portions of the lens from the colorant.

Contact lenses formed from silicone hydrogels have been disclosed. These contact lenses have higher oxygen permeability than traditional hydrogels. The improved oxygen permeability of these lenses has reduced the symptoms of hypoxia in contact lens users wearing them. Unfortunately, processes used to produce traditional hydrogel lenses, do not work to consistently produce silicone hydrogel contact lenses. An example of one such process is the production of tinted silicone hydrogel contact lenses.

Traditional hydrogel lenses made from etafilcon A have an oxygen permeability of about 20 (polarographic, edge corrected) and an advancing dynamic contact angle of about 60°. Silicone hydrogel lenses made from galyfilcon A have an oxygen permeability (measured via polarographic, edge corrected) of about 60 and an advancing dynamic contact angel of about 60°.

Processes that have been disclosed for producing tinted etafilcon A contact lenses, do not produce tinted silicone hydrogel contact lenses whose tints do not bleed, leach out, or smear. See, U.S. patent application Ser. No. 10/027,579. Therefore it would be useful to find a process that produces tinted silicone hydrogel lenses whose tints do not bleed, leach out, or smear. Such a process and its components are described below.

### DESCRIPTION OF THE FIGURES

FIGS. 1-4 are photographs of the printed lenses made in Examples 21-24.

### DETAILED DESCRIPTION OF THE INVENTION

This invention includes a process for producing a stable, tinted ophthalmic device comprising a hydrogel suitable for on eye use having an oxygen permeability of at least about 50 barrer, wherein said process comprises the following steps
(a) applying a colorant composition comprising a non-crosslinked binding co-polymer, a pigment, dye or mixture thereof and a printing solvent to at least a portion of a molding surface of an ophthalmic device mold,
(b) treating the mold of step (a) to reduce volatile components present in said colorant composition,
(c) dispensing into said treated mold of step (b) and over said colorant composition, a lens forming amount of an uncured hydrogel formulation, and
(d) curing said hydrogel formulation to form a stable, tinted ophthalmic device having an oxygen permeability of at least about 50 barrer.

As used herein, the term “ophthalmic devices” are devices that reside in or on the eye. These devices can provide optical correction, cosmetic enhancement, UV blocking, visible light or glare reduction, therapeutic effect, including wound healing, delivery of drugs or nutraceuticals, diagnostic evaluation or monitoring, or any combination thereof. The term lens includes, but is not limited to, soft contact lenses, hard contact lenses, intraocular lenses, overlay lenses, ocular inserts, and optical inserts.

As used herein “stable tinted devices” means that the none of the components from the colorant composition bleed or leach out from the device or from one portion of the device to another during storage or use.

As used herein “suitable for ophthalmic use without surface modification” means that the hydrogel formulation, if polymerized in a mold without the coating steps disclosed in the present application to impart visual effect, forms an ophthalmic device, which displays an advancing contact angle of less than about 80°, less than about 70° or less than about 60°. Examples of hydrogel formulations which are suitable for ophthalmic use without surface modification include galyfilcon, senfilcon, narafilcon and comfilcon.

As used herein “pigment” refers to insoluble organic or inorganic substances that impart color or other visual effects to another substance or mixture. Examples of organic pigments include, without limitation, pthalocyanine blue, pthalocyanine green, carbazole violet, vat orange #1, and the like and combinations thereof. Examples of useful inorganic pigments include, without limitation, iron oxide (brown, yellow, black or red), titanium dioxide, and the like, and combinations thereof. In addition to these pigments, soluble and non-soluble dyes may be used including, without limitation, dichlorotriazine and vinyl sulfone-based dyes. Examples of pigments also include cholesteric liquid crystals, such as Helicones® which impart sparkle, combinations thereof and the like. As used herein “dye” refers to soluble organic and inorganic coloring compounds which may be reactive or non-reactive. A wide variety of pigments and dyes are approved by the US. Food and Drug Administration and known to those of ordinary skill.

As used herein “ophthalmic device mold” refers to a solid surface that imparts optical character or shape to an ophthalmic device. The concave surface of the mold is used to form the front surface of ophthalmic devices and the convex surface of the mold is used to form the back surface of ophthalmic devices.

As used herein colorant composition means the mixture of binding polymer, solvent, pigments, dyes and other optional components used to impart color or other visual effects to the ophthalmic devices of the present invention.

A lens forming amount is the quantity of reactive mixture added to the concave mold. This amount varies depending upon the type mold (or molds) and the size and desired thickness and design of the ophthalmic device. See, for example, U.S. Pat. No. 4,565,348. Typically if a two mold process using concave and convex mold halves is used to prepare a soft contact lens the amount required to prepare that device is about 10 mg to about 100 mg.

As used herein, the term “(meth)” designates optional methyl substitution. Thus, a term such as “(meth)acrylate” denotes both methacrylic and acrylic radicals.

As used herein “reactive groups” are groups that can undergo free radical and/or cationic polymerization. Non-limiting examples of free radical reactive groups include (meth)acrylates, styryls, vinyls, vinyl ethers, C₁₋₆alkyl(meth)acrylates, (meth)acrylamides, C₁₋₆alkyl(meth)acrylamides, N-vinyllactams, N-vinylamides, C₂₋₁₂alkenyls, C₂₋₁₂alkenylphenyls, C₂₋₁₂alkenylnaphthyls, C₂₋₆alkenylphenylC₁₋₆alkyls, O-vinylcarbamates and O-vinylcarbonates. Non-limiting examples of cationic reactive groups include vinyl ethers or epoxide groups and mixtures thereof. In one embodiment the free radical reactive groups comprises (meth)acrylate, acryloxy, (meth)acrylamide, and mixtures thereof.

As used herein “reaction mixture” is the mixture components, including, reactive components, diluent (if used), initiators, crosslinkers and additives, which when subjected to polymer forming conditions form a polymer. Reactive components are the components in the reaction mixture, which upon polymerization, become a permanent part of the polymer, either via chemical bonding or entrapment or entanglement within the polymer matrix. For example, reactive monomers become part of the polymer via polymerization, while non-reactive polymeric internal wetting agents, such as PVP become part of the polymer via entrapment. The diluent (if used) and any additional processing aids, such as deblocking agents do not become part of the structure of the polymer and are not part of the reactive components

As used herein “volatile components” include but are not limited to solvent, unreacted monomer, oligomers having a molecular weight of less than about 10,000 Daltons, and components having a boiling point of less than about 250° C.

As used herein “non-crosslinked binding co-polymer” refers to a co-polymer containing one or more traditional monomers and one or more oxygen permeability enhancing monomers.

As used herein “traditional monomers” refer to monomers that may be cured, processed and hydrated to produce hydrogel lenses with oxygen permeabilities, measured via a polarographic method of less than about 50 barrers. Examples of traditional monomers include monomers containing polymerizable groups such as

acrylic groups; CH₂═CR—CX—(O)—,

where R is H or CH₃, X is OR¹ or NR¹R², and R¹ and R² are independently H, or C₁₋₁₀ alkyl); and

vinyl groups; R³C═CR⁴, where R³, and R⁴ are independently C1-10 alkyl, hydrogen or lactam.

Examples of specific traditional monomers include but are not limited to 2-hydroxyethyl(meth)acrylate, vinyl alcohol, N,N-dimethylacrylamide, 2-hydroxyethyl(meth)acrylamide, propylethyleneglycol mono(meth)acrylate, methyl methacrylate, (meth)acrylic acid, acrylic acid, N-vinyl pyrrolidone, N-vinyl-N-methylacetamide, N-vinyl-N-ethyl acetamide, N-vinyl-N-ethyl formamide, n-vinyl formamide, the reactive, hydrophilic polymeric internal wetting agents of Formulae of II, IV, VI and VII as disclosed in U.S. Pat. No. 7,249,848:

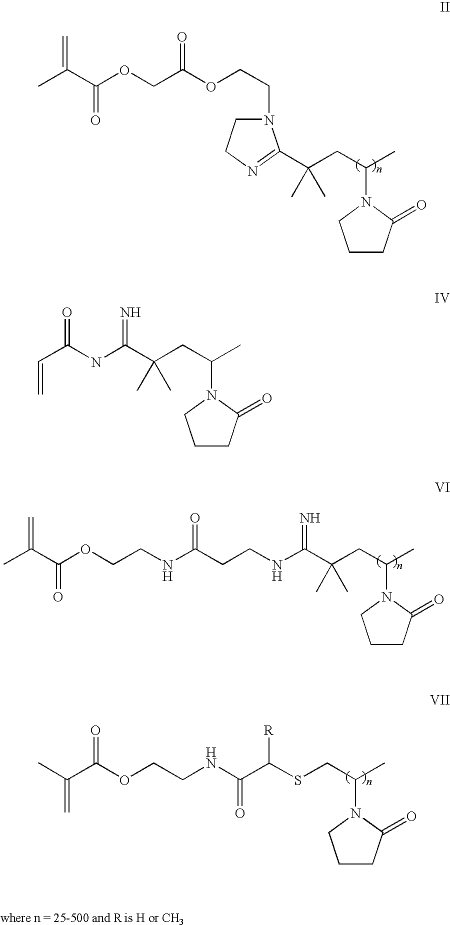

and mixtures thereof. In one embodiment the traditional monomers are N,N-dimethylacrylamide, 2-hydroxyethyl methacrylate, glycerol methacrylate, 2-hydroxyethyl methacrylamide, N-vinylpyrrolidone, polyethylene glycol monomethacrylate, methylacrylic acid, acrylic acid and mixtures thereof. In another embodiment the traditional monomers are 2-hydroxyethyl(meth)acrylate, hydroxyethyl(meth)acrylamide, N,N-dimethylacrylamide, and N-vinylpyrrolidone. In one embodiment the traditional monomers contain no more that one reactive group, excluding contaminants and by-products.

As used herein “oxygen permeability enhancing” components (or “OPE” components) include components that when included in the reactive mixture, cured, processed and hydrated produce hydrogel lenses with oxygen permeabilities of greater than about 50 barrers. Silicone-containing components are one example of such OPE components.

A silicone-containing component is one that contains at least one [—Si—O—Si] group, in a monomer, macromer or prepolymer. In one embodiment, the Si and attached O are present in the silicone-containing component in an amount greater than 20 weight percent, and in another embodiment greater than 30 weight percent of the total molecular weight of the silicone-containing component. In one embodiment the silicone-containing components comprise on reactive group, excluding contaminants and byproducts. Examples of silicone-containing components which are useful in this invention may be found in U.S. Pat. Nos. 3,808,178; 4,120,570; 4,136,250; 4,153,641; 4,740,533; 5,034,461 and 5,070,215, and EP080539. These references disclose many examples of olefinic silicone-containing components.

In one embodiment suitable silicone-containing components include compounds of Formula I

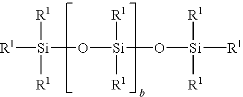

where

R¹ is independently selected from monovalent reactive groups, monovalent alkyl groups, or monovalent aryl groups, any of the foregoing which may further comprise functionality selected from hydroxy, amino, oxa, carboxy, alkyl carboxy, alkoxy, amido, carbamate, carbonate, halogen or combinations thereof; and monovalent siloxane chains comprising 1-100 Si—O repeat units which may further comprise functionality selected from alkyl, hydroxy, amino, oxa, carboxy, alkyl carboxy, alkoxy, amido, carbamate, halogen or combinations thereof;

b=0 to 500, where it is understood that when b is other than 0, b is a distribution having a mode equal to a stated value;

at least one R¹ comprises a monovalent reactive group, and in some embodiments between one and 3 R¹ comprise monovalent reactive groups.

Suitable monovalent alkyl and aryl groups include unsubstituted monovalent C₁ to C₁₆alkyl groups, C₆-C₁₄ aryl groups, such as substituted and unsubstituted methyl, ethyl, propyl, butyl, 2-hydroxypropyl, propoxypropyl, polyethyleneoxypropyl, combinations thereof and the like.

In one embodiment b is zero, one R¹ is a monovalent reactive group, and at least 3 R¹ are selected from monovalent alkyl groups having one to 16 carbon atoms, and in another embodiment from monovalent alkyl groups having one to 6 carbon atoms. Non-limiting examples of silicone monomers of this embodiment include 2-methyl-,2-hydroxy-3-[3-[1,3,3,3-tetramethyl-1-[(trimethylsilyl)oxy]disiloxanyl]propoxy]propyl ester (“SiGMA”), 2-hydroxy-3-methacryloxypropyloxypropyl-tris(trimethylsiloxy)silane, 3-methacryloxypropyltris(trimethylsiloxy)silane (“TRIS”), 3-methacryloxypropylbis(trimethylsiloxy)methylsilane and 3-methacryloxypropylpentamethyl disiloxane.

In another embodiment, b is 2 to 20, 3 to 15 or in some embodiments 3 to 10; at least one terminal R¹ comprises a monovalent reactive group and the remaining R¹ are selected from monovalent alkyl groups having 1 to 16 carbon atoms, and in another embodiment from monovalent alkyl groups having 1 to 6 carbon atoms. In yet another embodiment, b is 3 to 15, one terminal R¹ comprises a monovalent reactive group, the other terminal R¹ comprises a monovalent alkyl group having 1 to 6 carbon atoms and the remaining R¹ comprise monovalent alkyl group having 1 to 3 carbon atoms. Non-limiting examples of silicone components of this embodiment include (mono-(2-hydroxy-3-methacryloxypropyl)-propyl ether terminated polydimethylsiloxane (400-1000 MW)) (“OH-mPDMS”), monomethacryloxypropyl terminated mono-n-butyl terminated polydimethylsiloxanes (800-1000 MW), (“mPDMS”).

In another embodiment b is 5 to 400 or from 10 to 300, both terminal R¹ comprise monovalent reactive groups and the remaining R¹ are independently selected from monovalent alkyl groups having 1 to 18 carbon atoms which may have ether linkages between carbon atoms and may further comprise halogen. In another embodiment, one to four R¹ comprises a vinyl carbonate or carbamate of the formula:

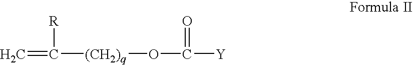

wherein: Y denotes O—, S— or NH—;
R denotes, hydrogen or methyl; and q is 0 or 1.
The silicone-containing vinyl carbonate or vinyl carbamate monomers specifically include: 1,3-bis[4-(vinyloxycarbonyloxy)but-1-yl]tetramethyl-disiloxane; 3-(vinyloxycarbonylthio)propyl-[tris(trimethylsiloxy)silane]; 3-[tris(trimethylsiloxy)silyl]propyl allyl carbamate; 3-[tris(trimethylsiloxy)silyl]propyl vinyl carbamate; trimethylsilylethyl vinyl carbonate; trimethylsilylmethyl vinyl carbonate, and

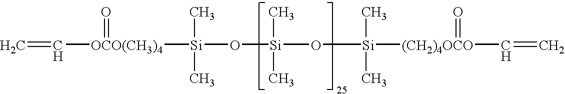

Where biomedical devices with modulus below about 200 are desired, only one R¹ shall comprise a monovalent reactive group and no more than two of the remaining R¹ groups will comprise monovalent siloxane groups.

Another class of silicone-containing components includes polyurethane macromers of Formulae IV-VI

(*D*A*D*G)ₐ*D*D*E¹;

E(*D*G*D*A)ₐ*D*G*D*E¹ or;

E(*D*A*D*G)ₐ*D*A*D*E¹

wherein:
D denotes an alkyl diradical, an alkyl cycloalkyl diradical, a cycloalkyl diradical, an aryl diradical or an alkylaryl diradical having 6 to 30 carbon atoms,
G denotes an alkyl diradical, a cycloalkyl diradical, an alkyl cycloalkyl diradical, an aryl diradical or an alkylaryl diradical having 1 to 40 carbon atoms and which may contain ether, thio or amine linkages in the main chain;
* denotes a urethane or ureido linkage;
ₐ is at least 1;
A denotes a divalent polymeric radical of formula:

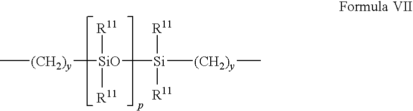

R¹¹ independently denotes an alkyl or fluoro-substituted alkyl group having 1 to 10 carbon atoms which may contain ether linkages between carbon atoms; y is at least 1; and p provides a moiety weight of 400 to 10,000; each of E and E¹ independently denotes a polymerizable unsaturated organic radical represented by formula:

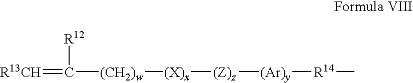

wherein: R¹² is hydrogen or methyl; R¹³ is hydrogen, an alkyl radical having 1 to 6 carbon atoms, or a —CO—Y—R¹⁵ radical wherein Y is —O—,Y—S— or —NH—; R¹⁴ is a divalent radical having 1 to 12 carbon atoms; X denotes —CO— or —OCO—; Z denotes —O— or —NH—; Ar denotes an aromatic radical having 6 to 30 carbon atoms; w is 0 to 6; x is 0 or 1; y is 0 or 1; and z is 0 or 1. In one embodiment the silicone-containing component comprises a polyurethane macromer represented by the following formula:

Formula IX

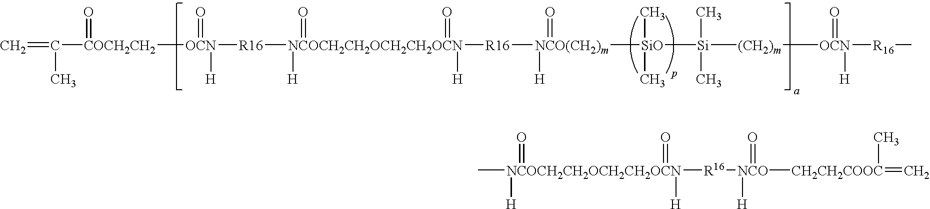

wherein R¹⁶ is a diradical of a diisocyanate after removal of the isocyanate group, such as the diradical of isophorone diisocyanate. Another suitable silicone containing macromer is compound of formula X (in which x+y is a number in the range of 10 to 30) formed by the reaction of fluoroether, hydroxy-terminated polydimethylsiloxane, isophorone diisocyanate and isocyanatoethylmethacrylate.

### Formula X

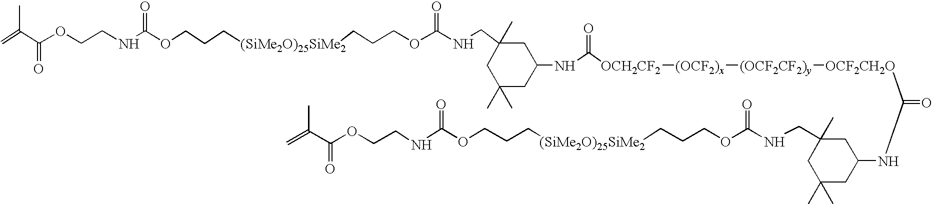

Other silicone-containing components suitable for use in this invention include those described is WO 96/31792 such as macromers containing polysiloxane, polyalkylene ether, diisocyanate, polyfluorinated hydrocarbon, polyfluorinated ether and polysaccharide groups. Another class of suitable silicone-containing components includes silicone containing macromers made via GTP, such as those disclosed in U.S. Pat. Nos. 5,314,960, 5,331,067, 5,244,981, 5,371,147 and 6,367,929. U.S. Pat. Nos. 5,321,108; 5,387,662 and 5,539,016 describe polysiloxanes with a polar fluorinated graft or side group having a hydrogen atom attached to a terminal difluoro-substituted carbon atom. US 2002/0016383 describe hydrophilic siloxanyl methacrylates containing ether and siloxanyl linkages and crosslinkable monomers containing polyether and polysiloxanyl groups. Any of the foregoing polysiloxanes can also be used as the silicone-containing component in this invention.

Additional examples of silicone monomers include but are not limited to hydrophilic siloxane-containing monomers such as those described in U.S. Pat. No. 4,711,943, vinyl carbamate or carbonate analogs, such as those described in U.S. Pat. No. 5,070,215 and monofunctional monomers contained in U.S. Pat. No. 6,020,445. In one embodiment the OPE components comprise at least one selected from 3-methacryloxypropyltris(trimethylsiloxy)silane, monomethacryloxypropyl terminated polydimethylsiloxanes, polydimethylsiloxanes, 3-methacrylxoypropylbis(trimethylsiloxy)methylsilane, methacryloxypropylpentamethyl disiloxane, mono-(3-methacryloxy-2-hydroxypropyloxy)propyl terminated, mono-butyl terminated polydimethylsiloxane, and mixtures thereof.

Aside from silicone monomers, OPE monomers include monomers that when polymerized are loosely bound together and have a degree of free volume between chains. Such monomers are typically bulky, which increases the free volume between chains. The size of this steric effect can be estimated using empirical polymer force constants which has been coined as Permachor. (Polym./Plast. Technol. Eng. 8(2) “Barrier Polymers” (1977). Monomers of this type having a permachor value equal to or less than about 30. Examples of such non-traditional polymers include 1,4-dimethylenecyclohexane, and cisisoprene.

The non-crosslinked binding co-polymers of the present invention are formed from the reaction of at least one traditional monomer and OPE component. The non-crosslinked binding co-polymers have molecular weights of about 10 kD to about 1000 kD, and in some embodiments from about 25 to about 500 kD. The non-crosslinked binding copolymers are substantially free of unreacted reactive groups, and in one embodiment are free of unreacted reactive groups. The non-crosslinked binding co-polymers may contain about 10 to about 90 weight % residues derived from OPE components, and in some embodiments from about 20 to about 60 weight % residues derived from OPE components.

It is not necessary for the ratio of traditional and OPE monomers in the non-crosslinked binding copolymer to match the ratio of those components in the reactive mixture in embodiments where the binding polymer and reactive mixture are compatible. However, in one embodiment where the binding polymer is not compatible with the reactive mixture, the ratio of traditional to OPE monomers in the non-crosslinked binding co-polymer is similar to the relative ratio of those components in the hydrogel formulation. For example if the hydrogel formulation contains traditional and OPE monomers 2-hydroxyethyl methacrylate and mono-methacryloxypropyl terminated polydimethylsiloxane in a ratio 20:80, the ratio of the weight percent of those traditional to OPE momomers in the non-crosslinked binding co-polymer will be about 10:90 and about 30:70.

In addition to the traditional monomers and OPE components, the mixture from which the non-crosslinked binding co-polymer is made may also include additional reactive and non-reactive components such as UV absorbers, medicinal agents, antimicrobial compounds, reactive tints, copolymerizable dyes, chain transfer agents, wetting agents combinations thereof and the like. When non-reactive components are added, they may be added to the reactive mixture from which the non-crosslinked binding co-polymer is made, or may be incorporated into the binding copolymer after the binding copolymer is formed. When additional components are added after the binding polymer is formed, the additional component may be mechanically mixed into the binding polymer.

Generally at least one solvent is used to form the colorant composition. In one embodiment, where the colorant composition is incorporated in or on an ophthalmic device, the solvent comprises at least “mid-boiling solvent” having a boiling point between about 120 and about 150° C. Mid-boiling solvents allow for sufficient drying and transfer of the colorant composition to the front curve. Examples of mid-boiling solvents include 1-ethoxy-2-propanol (1E2P), 1,2-octanediol, 3-methyl-3-pentanol, 1-pentanol, methyl lactate, 1-methoxy-2-propanol, mixtures thereof and the like. In one embodiment the colorant composition comprises 1E2P. The solvents should solubilize the binding polymer and any additional components (other than the pigments) that are included in the colorant composition. For example, in one embodiment where at least one wetting agent is included in the colorant composition, the mid-boiling solvents may not provide the desired salvation. In this embodiment, additional polar solvents may be included in the colorant composition. Examples of suitable polar solvents include methanol, ethanol, t-amyl alcohol, propanol, butanol, mixtures thereof and the like.

In some embodiments incorporation of at least one polar solvent has resulted in decreased protein, mucin, and lipocalin uptake by the resulting ophthalmic device. Decreases in uptake of at least one of protein, mucin or lipocalin of at least about 5% and in some embodiments at least about 10% compared to lenses made from colorant compositions without at least one polar solvent may be achieved. Mixtures of polar solvents of low boiling points (<120° C.) with solvents of mid-point boiling points (120-150° C.) provides the ophthalmic device with desirable compatibility toward the components of human tears, yet still provides the same pad printing process ease as compared to traditional mid-point boiling points (120-150° C.) solvents alone.

Generally the solvent is added to the colorant composition in a printing effective amount. A printing effective amount is the amount desirable to produce a colorant composition having a viscosity suitable for the printing process to be used. For example, where pad printing is used, the colorant composition has a viscosity of between about 500 and 2500 about cps, and in some embodiments from about 500 to about 1500 cps and in other embodiments between about 1000 cps. For some embodiments colorant compositions having a viscosity of about 1000 cps comprise from about 20 to about 80 weight % solvent, and in some embodiments from about 30 to about 70 weight % solvent, based upon all components in the colorant composition. When polar solvents are included they may be included in amounts between about 20 and about 80 weight % and about 30 to about 70 weight % based upon the total amount of solvent used in the colorant composition.

In order to prepare the non-crosslinked binding copolymer, the monomers in the solvent must be combined with at least one initiator such as a thermal free radical initiator. Thermal initiators generate free radicals at moderately elevated temperatures. Examples of suitable thermal initiators include lauroyl peroxide, benzoyl peroxide, isopropyl percarbonate, 2,2′-azobisisobutyronitrile and 2,2′-azobis-2-methylbutyronitrile. Suitable amounts of initiator include from about 0.2 to about 10 weight %, and in some embodiments from about 02 weight % to about 5 weight %. The non-crosslinked binding co-polymer may be photo polymerized as well. That is, photoinitiators in place of thermal initiators may be employed. The choice of polymerization conditions are selected to produce a non-crosslinked binding co-polymer having a preferred molecular weight of about 10 kD to about 1000 kD, more preferably about 25-500 kD.

Generally reaction conditions for forming the non-crosslinked binding copolymer include those reaction temperatures from about 30° C. to about 180° C., and in some embodiments from about 50° C. to about 100° C. and reaction times of about 4 to about 24 hours. The reaction may be conducted at ambient pressure.

Chain transfer agents may also be included where control of molecular weight is desired. In some embodiments a polydispersity of about 1 to about 10 is desired, and in others a polydispersity of about 1 to about 3 is desired.

The non-crosslinked binding copolymers may be purified prior to use by any known methods, such as, but not limited to organic work-up, precipitation in an appropriate solvent, various chromatographic methods, dialysis, combinations thereof and the like.

Once formed, the non-crosslinked binding co-polymer may be diluted with a “printing solvent” to attain a colorant composition having a viscosity suitable for use in the processes of the invention. This printing solvent can be the same or different from the solvent used to form said non-crosslinked binding co-polymer. In one embodiment suitable printing solvents include 1ethoxy-2-propanol, ethanol, heptane, or combinations comprising at least one of these solvents provided that the non-crosslinked binding polymer is soluble in the printing solvents. The colorant composition has a viscosity of about 500 to about 8000 cps (centipoises), and in another embodiment about 500 to about 2500 cps with or without added pigments for a pad printing process and a viscosity of less than about 500 cps for an ink jet process. The viscosity of the colorant composition may be tailored to the process. The viscosity is measured at 23° C. on a Brookfield viscometer equipped with an S82 or an S31 spindle and rotating at 100 rpm.

Viscosity is directly related to solid content. For viscosity ranges of about 500 to about 2500 cps, the colorant compositions generally have solid contents of about 20% w/w to about 60% w/w, in some embodiments from about 35 to about 55% w/w, and in some embodiments of about 43% w/w. The viscosity/solids content relationship may be tailored to the selected printing process.

It has been surprising found that non-crosslinked binding copolymers having glass transition temperatures, Tg, greater than about 60° C., in some embodiments greater than about 70° C. and in others greater than about 80° C. form colorant compositions displaying improved print quality. The Tg of the non-crosslinked binding copolymer is measured without additional additives, even if the additives are to be used in the colorant composition.

The colorant compositions further comprise at least one pigment, dye or combination thereof. One ordinarily skilled in the art will recognize that each pigment used will have a critical pigment volume for the solvents selected. The critical pigment volume may be determined by any known means and, generally, is a volume based on the efficiency of a solvent and the binding polymer to suspend the pigment particles for example, as disclosed in Patton, Temple C., Paint Flow and Pigment Dispersion, 2d ed., pp 126-300 (1993).

The opacity of the colorant may be controlled by varying the pigment concentration and the pigment particle size used. Alternatively, an opacifying agent may be used. Suitable opacifying agents, such as for example titanium dioxide or zinc oxide, are commercially available.

In one embodiment, the colorant composition comprises about 0.2 to about 25 weight percent of pigment, about 30 to about 45 weight percent of binding polymer, about 40 to about 70 weight percent of solvents, about 0 to about 25 weight percent of titanium dioxide, and about 0.2 to about 7 weight percent of plasticizer is used. The weight percentages are based on the total weight of the colorant mixture.

The binding polymer may be loaded with about 0.2 to about 25 weight percent based on the weight of the colorant for organic pigments and about 0.2 to about 50 weight percent for inorganic pigments. However, high pigment concentrations may impart a very dark hue. Therefore, preferably about 0.2 to about 7 weight percent of organic pigments and about 0 to about 20 weight percent of inorganic pigments are used. Combinations of pigments may be used in ratios dependent upon the color, shade, and hue desired.

In one embodiment the non-crosslinked binding copolymer is mixed with solvents and components that do not impart color or visual effect. This coating composition may be used to form a clear layer on an ophthalmic device mold prior to application of the color composition. Compositions which do not contain pigments are referred to as “colorless coating compositions”.

The colorant composition is applied to at least a part of at least one ophthalmic device mold surface. In one embodiment the colorant composition is applied to at least a portion of the concave mold surface. In another embodiment a colorless coating composition is applied to at least a portion of the concave mold surface, then the colorant composition is applied on the colorless coating composition.

The colorant composition may be applied to the mold surface by any means known in the art. Suitable methods include, but are not limited to pad printing and ink jet printing. In one embodiment, pad printers such as those described in U.S. Pat. No. 5,637,265 are used to apply the colorant composition to the lens mold. In one embodiment of this process, the pad printer dips into a portion of the colorant composition and air dries for about 0.5 second to about 60 minutes before the pad printer touches the surface of the lens mold. The colorant composition may be applied in a single pass or in multiple passes.

The colorant composition is applied in an amount sufficient to impart the desired level of tint to the lens to be produced (a “tinting effective amount”). In one embodiment, about 0.5 mg to about 4.0 mg of colorant is used per lens.

The colorant composition may be treated to remove volatile components after it is applied to the mold surface. Such methods include evacuating the molds in a chamber, aging the molds at room temperature under ambient atmosphere or under any of the following gases N₂ or O₂, aging the molds at about ambient temperature to about 75° C. for at least 2 minutes to about 1 week, from about 2 minutes to about 24 hours or from about 2 minutes to about 6 minutes, or a combination of such steps. This step may be repeated for each layer of colorant composition applied to the mold.

Ophthalmic device molds are made of a number of materials. Mold part material can include a polyolefin of one or more of: polypropylene, polystyrene, polyethylene, polymethyl methacrylate, and modified polyolefins.

A preferred alicyclic co-polymer contains two different alicyclic polymers and is sold by Zeon Chemicals L.P. under the trade name ZEONOR. There are several different grades of ZEONOR. Various grades may have glass transition temperatures ranging from 105° C. to 160° C. A specifically preferred material is ZEONOR 1060R.

Other mold materials that may be combined with one or more additives to form an ophthalmic lens mold include, for example, Zieglar-Natta polypropylene resins (sometimes referred to as znPP). One exemplary Zieglar-Natta polypropylene resin is available under the name PP 9544 MED. PP 9544 MED is a clarified random copolymer for clean molding as per FDA regulation 21 CFR (c)3.2 made available by ExxonMobile Chemical Company. PP 9544 MED is a random copolymer (znPP) with ethylene group (hereinafter 9544 MED). Other exemplary Zieglar-Natta polypropylene resins include: Atofina Polypropylene 3761 and Atofina Polypropylene 3620WZ.

Still further, molds may contain polymers such as polypropylene, polyethylene, polystyrene, polymethyl methacrylate, modified polyolefins containing an alicyclic moiety in the main chain and cyclic polyolefins. This blend can be used on either or both mold halves, where it is preferred that this blend is used on the back curve and the front curve consists of the alicyclic co-polymers. The preferred materials are Zeonor, 1060R, polypropylene and Zeonor blended with Tuftec H1051 is a polymer blend of styrene, ethylene, butadiene (SEBS), available from Ashai Kasei Chemical Corp., Japan.

The molds may be made separately, or may be made in the same process as forming the ophthalmic devices.

Once the colorant composition has been applied to the mold, and treated if desired, an ophthalmic device forming amount of reactive mixture is dispensed into the convex mold cavity. In one embodiment the reactive mixture comprises at least one OPE component and at least one hydrophilic component. Any of the OPE components described above may be used to make the hydrogel formulations. Suitable hydrophilic components include the hydrophilic monomers described above, as well as high molecular weight hydrophilic polymers such as those described in U.S. Pat. No. 6,367,929, U.S. Pat. No. 6,822,016 and US2008/0045612.

Suitable high molecular weight hydrophilic polymers increase the wettability of the cured silicone hydrogels and have an average molecular weight of no less than 50,000 Daltons, and, in some embodiments between about 100,000 to 500,000 Daltons, between 300,000 to about 400,000 Daltons, in other embodiments between about 320,000 and about 370,000 Daltons.

Alternatively, the molecular weight of hydrophilic polymers of the invention can be expressed by the K-value, based on kinematic viscosity measurements, as described in N-Vinyl Amide Polymers by E. S. Barabas in Encyclopedia of Polymer Science and Engineering, Second edition, Vol 17, pgs. 198-257, John Wiley & Sons Inc. When expressed in this manner, hydrophilic polymers having K-values of 46-100 are used. When included, the high molecular weight hydrophilic polymers are present in the formulations in an amount of about 1 to about 20 weight percent, in some embodiments about 3 to about 15 percent, and in others between about 5 to about 15 percent.

Examples of high molecular weight hydrophilic polymers include but are not limited to polyamides, polylactones, polyimides and polylactams. In one embodiment the high molecular weight hydrophilic polymers are those that contain a cyclic moiety in their backbone, such as a cyclic amide or cyclic imide. In other embodiments the high molecular weight hydrophilic polymer is an acyclic polyamide. High molecular weight hydrophilic polymers include but are not limited to polymers and copolymers of poly-N-vinyl pyrrolidone, poly-N-vinyl-2-piperidone, poly-N-vinyl-2-caprolactam, poly-N-vinyl-3-methyl-2-caprolactam, poly-N-vinyl-3-methyl-2-piperidone, poly-N-vinyl-4-methyl-2-piperidone, poly-N-vinyl-4-methyl-2-caprolactam, poly-N-vinyl-3-ethyl-2-pyrrolidone, and poly-N-vinyl-4,5-dimethyl-2-pyrrolidone, polyvinyl-N-_ methylacetamide, polyvinylacetamide, polyvinyl-N-methylpropionamide, polyvinyl-N-methyl-2-methylpropionamide, polyvinyl-2-methylpropionamide, polyvinyl-N,N′-dimethylurea, polyvinylimidazole, poly-N-N-dimethylacrylamide, polyvinyl alcohol, polyacrylic acid, polyethylene oxide, poly 2 ethyl oxazoline, heparin polysaccharides and polysaccharides. In one embodiment the high molecular weight hydrophilic polymer comprises polymers or copolymers of poly-N-vinylpyrrolidone, polyvinyl-N-methylacetamide, poly-N-N-dimethylacrylamide, polyvinyl alcohol, polyacrylic acid, mixtures thereof and the like.

The hydrogel formulations of the present invention may also comprise at least one compatibilizing component. Suitable compatibilizing components have a number average molecular weight of about less than 5000 Daltons, in some embodiments less than about 3000 Daltons, at least one hydroxyl group and contain at least one polymerizable group. Macromers (number average molecular weights of between about 5000 and about 15,000 Daltons) may also be used so long as they have the compatibilizing functionality described herein. If a compatibilizing macromer is used it may still be necessary to add an additional compatibilizing component to get the desired level of wettability in the resulting ophthalmic device.

In one embodiment, the compatibilizing components of the present invention comprise at least one hydroxyl group and at least one “—Si—O—Si—” group. In some embodiments, the silicone and its attached oxygen account for more than about 10 weight percent of said compatibilizing component, and in some embodiments more than about 20 weight percent. The ratio of Si to OH in the compatibilizing component is less than about 15:1, and preferably between about 1:1 to about 10:1. In some embodiments primary alcohols have provided improved compatibility compared to secondary alcohols.

Examples of compatibilizing components include monomers of Formulae I and II disclosed in U.S. Pat. No. 6,822,016. Specific examples include (3-methacryloxy-2-hydroxypropyloxy)propylbis(trimethylsiloxy)methylsilane, (3-methacryloxy-2-hydroxypropyloxy)propyltris(trimethylsiloxy)silane, bis-3-methacryloxy-2-hydroxypropyloxypropyl polydimethylsiloxane, mono-(3-methacryloxy-2-hydroxypropyloxy)propyl terminated, mono-butyl terminated polydimethylsiloxane, mixtures thereof and the like.

One class of suitable macromers include hydroxyl functionalized macromers made by Group Transfer Polymerization (GTP), or styrene functionalized prepolymers of hydroxyl functional methacrylates and silicone methacrylates and are disclosed in U.S. Pat. No. 6,367,929, which is incorporated herein by reference.

An “effective amount” of the compatibilizing component of the invention is the amount needed to compatibilize or dissolve the high molecular weight hydrophilic polymer and the other components of the polymer formulation. Thus, the amount of compatibilizing component will depend in part on the amount of hydrophilic polymer which is used, with more compatibilizing component being needed to compatibilize higher concentrations of high molecular weight hydrophilic polymer. Effective amounts of compatibilizing component in the polymer formulation include about 5% (weight percent, based on the total weight of the reactive components) to about 90%, preferably about 10% to about 80%, most preferably, about 20% to about 50%.

The hydrogel formulations may also include crosslinking compounds, photoinitiators, diluents, and any of the additional components described above.

Ophthalmic devices of the invention include soft contact lenses made from silicone elastomers, silicone hydrogels, and fluorohydrogels (“hydrogel formulations”) that may be cured, processed and hydrated to form ophthalmic devices that have an oxygen permeability (“Dk”) of greater than about 50 barrer, measured via a polarographic method, boundary and edge corrected. In one embodiment the ophthalmic devices of the invention have an oxygen permeability of greater than about 60, and in another, greater than about 80.

Generally the reactive mixture is cured and subsequently hydrated. Various processes are known for molding the reactive mixture in the production of contact lenses, including spincasting and static casting. Spincasting methods are disclosed in U.S. Pat. Nos. 3,408,429 and 3,660,545, and static casting methods are disclosed in U.S. Pat. Nos. 4,113,224 and 4,197,266 all of these patents are incorporated herein by reference.

The mold containing the lens material then is exposed to conditions suitable to form the lens. The precise conditions will depend upon the components of lens material selected and are within the skill of one of ordinary skill in the art to determine. Curing may be effected using a combination of heat or light. In one embodiment the reactive mixture is cured via exposure to irradiation with UV or visible light. In one embodiment, primarily visible light is used. Once curing is completed, the lens is released from the mold and may be treated with a solvent to remove the diluent (if used) or any traces of unreacted components. The lens is then hydrated to form the hydrogel lens.

Examples of hydrogel formulations are disclosed in U.S. Pat. No. 5,710,302, WO 9421698, EP 406161, JP 2000016905, U.S. Pat. No. 5,998,498, U.S. Pat. No. 6,367,929, U.S. Pat. No. 6,822,016, U.S. Pat. No. 6,087,415, U.S. Pat. No. 5,760,100, U.S. Pat. No. 5,776,999, U.S. Pat. No. 5,789,461, U.S. Pat. No. 5,849,811, and U.S. Pat. No. 5,965,631 and U.S. Pat. No. 5,070,166. Ophthalmic devices of the invention include soft contact lenses comprising galyfilcon A, senofilcon A, genfilcon A, lenefilcon A, comfilcon A, acquafilcon A, balafilcon A, lotrafilcon A, narafilcon A. In one embodiment, medical devices of the invention are soft contact lenses made from galyfilcon A, senofilcon A, acquafilcon A, and narafilcon A. The foregoing is a list of polymer formulations by their US Adopted Names (“USAN”). Each USAN lists the components included in the reactive mixture for that formulation. A disclosure of a USAN name without a letter designation, for example “senofilcon” includes all formulations having the same components, but in any amount.

The cured ophthalmic devices may be subjected to further surface treatments or coatings, including by plasma treatments, grafting, coating and the like. Alternatively, the cured ophthalmic devices may be contacted with non-reactive polymers, such as polyacrylic acid, such as disclosed in U.S. Pat. Nos. 6,689,480 or 6,428,839, or may be contacted with polymers having alternating charges, such as the “layer by layer” coating processes disclosed in U.S. Pat. No. 6,827,966; U.S. Pat. No. 6,451,871; U.S. Pat. No. 6,896,926; U.S. Pat. No. 6,793,973. When non-reactive polymers are used, they should have a molecular weight sufficient to allow for persistent association with the ophthalmic device. Weight average molecular weights of at least about 5,000, and in some embodiments at least about 20,000 are desirable. The surface treatment may improve the wettability or lubricity of the lens, impart antimicrobial activity or any other functionality.

Alternatively, or in addition to the surface treatments described above, additional components may be added to the non-crosslinked binding co-polymers to modify the properties of the resulting ophthalmic device. Such components may include internal wetting agents, pharmaceutical or nutraceutical components and components which would alter the affinity of the lens toward components of human tears. As described above, these components may be added during the polymerization of the binding polymer or may be admixed or intercalated into the binding polymer after formation.

“Internal wetting agents” are polymeric substances that improve the wettability of a cured silicone hydrogel formulation but are not surface treatments as discussed above. They may be homopolymers, block co-polymers, and amphiphilic block co-polymers (as disclosed in U.S. Pat. No. 7,247,692), and lactam polymer derivatives (as disclosed in U.S. Pat. No. 7,473,738) as well as any of the high molecular weight hydrophilic polymers described above.

Such internal wetting agents are substantially non-polymerizable. As used herein, substantially non-polymerizable means that when the internal wetting agents are polymerized with other polymerizable components, the internal wetting agents are incorporated into silicone hydrogel formulations or the non-crosslinked binding co-polymers without significant covalent bonding to the silicone hydrogels or the non-crosslinked co-polymers. The absence of significant covalent bonding means that while a minor degree of covalent bonding may be present, it is incidental to the retention of the internal wetting agent in the silicone hydrogel matrix. Whatever incidental covalent bonding may be present, it would not by itself be sufficient to retain the internal wetting agent in the hydrogel matrix. Instead, the vastly predominating effect keeping the internal wetting agent associated with the silicone hydrogel is entrapment. The internal wetting agent is “entrapped”, according to this specification, when it is physically retained within a silicone hydrogel matrix. This is done via entanglement of the polymer chain of the internal wetting within the silicone hydrogel polymer matrix. It should be noted that van der Waals forces, dipole-dipole interactions, electrostatic attraction and hydrogen bonding will also contribute to this entrapment.

Internal wetting agents have a weight average molecular weight of about 2000 Daltons to about 2,000,000 Daltons, molecular weights of greater than about 5,000 Daltons; more preferably between about 5,000 to about 2,000,000 Daltons are suitable. In some embodiments, lower molecular weights from between about 5,000 to about 180,000 Daltons, most preferably about 5,000 to about 150,000 Daltons may be preferred, while in others higher molecular weight ranges, from about 60,000 to about 2,000,000 Daltons, preferably between about 100,000 to about 1,800,000 Daltons, more preferably about 180,000 to about 1,500,000 Daltons and most preferably from about 180,000 to about 1,000,000 (all weight average molecular weight) may be used. The molecular weights for polymers having a molecular weight greater than about 2000 Daltons may be determined by gel permeation chromatography (GPC) {size exclusion chromatography (SEC)} using hexafluoroisopropanol as solvent, and relate, unless otherwise stated, to poly(2-vinylpyridine) calibration standards (For other methods see, Journal of Liquid Chromatography, 10 ( ), 1127-1150 (1987))

Internal wetting agents include but are not limited to the high molecular weight hydrophilic polymers described above. In one embodiment wetting agents are selected from poly(N-vinyl-2-pyrrolidone), poly-2-ethyl-2-oxazoline, poly(N,N-dimethylacrylamide), and polyvinyl alcohol. The preferred internal wetting agents are poly(N-vinyl-2-pyrrolidone), poly-2-ethyl-2-oxazoline, polyvinylmethlacetamide and mixtures thereof. The particularly preferred internal wetting agent is poly(N-vinyl-2-pyrrolidone) having a weight average molecular weight of greater than about 60 kD to about 2000 kD. When internal wetting agents are added to non-crosslinked binding polymer the internal wetting agents are about 1% to about 30%, preferably about 12 to about 26% by weight of these agents are added to the non-crosslinked binding polymer. For example, if PVP K30 is used about 0.12 to about 0.26 g of that substance is added per gram of non-crosslinked binding polymer.

The effectiveness of such agents at increasing the wettability of the resulting ophthalmic devices may be assessed by measuring the dynamic contact angle or DCA.

The process may contain additional steps. For example, the process may comprise steps for printing multiple layers of colorant composition, colorless coating compositions, and combinations thereof. Multiple layers of colorant composition may be applied, each containing a different color or mixture of colors to produce ophthalmic devices having a realistic depth and variation of color. Alternatively, multiple layers of colorant compositions may be applied wherein the layers provide different visual effects, such as color, sparkle, UV absorption, light blocking and the like. Alternatively, layers of colorless coating compositions and colorant compositions may be used. For example, a colorless coating composition may be applied first as a topcoat, followed by one or a plurality of applications of the same or different colorant compositions. The colorless coating compositions and colorant compositions may also be alternated or applied in any order or combination.

The process of the present invention may optionally comprise a colorant composition swell step. If included in the process, the swelling is carried out under conditions suitable to swell the colorant to about 1 to about 4 times its dried thickness. Typically, such swelling may be achieved in from about 1 to about 30 minutes at about 40 to about 68° C.

For example, in one embodiment, the invention includes a process for producing a stable tinted ophthalmic device comprising a hydrogel, having an oxygen permeability of greater than about 50, wherein said process comprises:
(a) applying at least one colorant composition comprising at least one non-crosslinked binding co-polymer at least one pigment, dye or combination thereof and at least one printing solvent to at least a portion of at least one surface of an ophthalmic device mold,
(b) applying a colorless coating composition comprising at least one non-crosslinked binding co-polymer and at least one printing solvent over at least a portion of the colorant composition of step (a)
(c) treating the mold of step (b) to reduce the amount of volatile components present in said colorant or colorless coating compositions;
(d) adding over the colorless coating composition of step b and in an amount required to prepare an ophthalmic device, an uncured hydrogel formulation, wherein said hydrogel formulation, when cured, has a oxygen permeability of greater than about 50, and
(e) curing said hydrogel formulation to form a stable tinted ophthalmic device.

Still further the invention includes a process for producing a stable tinted ophthalmic device comprising a hydrogel, having an oxygen permeability of greater than about 50, wherein said process comprises:
(a) applying at least one colorless coating composition comprising at least one non-crosslinked binding co-polymer and at least one printing solvent to at least a portion of at least one surface of an ophthalmic device mold,
(b) applying at least one colorant composition comprising at least one non-crosslinked binding co-polymer, at least one pigment, dye or combination thereof and at least one printing solvent over the colorless coating composition of step (a);
(c) treating the mold of step (b) to reduce the amount of volatile components present in the colorant or colorless coating compositions;
(d) adding over the colorant composition applied in step b, a reactive mixture, in an amount up to an amount required to prepare an ophthalmic device, wherein said reactive mixture, when cured, has a oxygen permeability of greater than about 50, and
(e) curing said reactive to form a stable tinted ophthalmic device.

In addition, this invention includes processes as described above in which the hydrogel formulations are suitable for on eye use without surface modification.

In addition, this invention includes a composition for use in the production of stable tinted hydrogel ophthalmic devices having an oxygen permeability of greater than about 50 comprising at least one non-crosslinked binding co-polymer, at least one printing solvent, and at least one pigment, dye or mixture thereof. The composition may further comprise at least one internal wetting agent. In one embodiment, the non-crosslinked binding co-polymer comprises a Tg of greater than about 60° C.

Yet still further the invention includes a stable tinted hydrogel ophthalmic device having an oxygen transmissibility of greater than about 50 barrer/mm comprising a non-crosslinked binding co-polymer.

This invention further includes a stable tinted ophthalmic device comprising a hydrogel, suitable for on eye use, having an oxygen permeability of greater than about 50, prepared by a process comprising:
(a) applying at least one colorant composition comprising at least one non-crosslinked binding co-polymer, at least one pigment, dye or mixture thereof and at least one printing solvent to a surface of an ophthalmic device mold,
(b) treating the mold after step (a) to reduce the amount of volatile components present in the colorant composition;
(c) adding, over the treated mold of step (b) and in an amount up to an amount required to prepare an ophthalmic device, a reactive mixture, wherein said reactive mixture, when cured, has a oxygen permeability of greater than about 50, and
(d) curing said hydrogel formulation to form a stable tinted ophthalmic device.

Yet still further the invention includes, a stable tinted ophthalmic device comprising a hydrogel suitable for on eye use, having an oxygen permeability of greater than about 50, prepared by a process comprising
(a) applying at least one colorless coating composition comprising at least one non-crosslinked binding co-polymer and at least one printing solvent to at least a portion of at least one surface of an ophthalmic device mold,
(b) applying at least one colorant composition comprising at least one non-crosslinked binding co-polymer, at least one pigment, dye or mixture thereof and at least one printing solvent over the coating composition of step (a)
(c) applying a composition comprising at least one non-crosslinked binding co-polymer and at least one printing solvent over at least a portion of the colorant composition applied in step (b)
(d) treating the mold of step (c) to reduce the amount of volatile components contained in either the colorless coating composition, the colorant composition or both;
(e) adding, over the colorant composition applied in step (c), an amount of hydrogel formulation up to the amount required to prepare an ophthalmic device, an uncured hydrogel formulation, wherein said hydrogel formulation when cured, has a oxygen permeability of greater than about 50, and
(f) curing said hydrogel formulation to form a stable tinted ophthalmic device.
The terms non-crosslinked binding co-polymer, pigment, dye, stable tinted devices, ophthalmic device mold, ophthalmic device, applying, treating volatile components, amount required, printing solvent, and hydrogel formulations, have the aforementioned meanings and preferred species. Internal wetting agents may be added to one of more steps of the processes of the invention and if so internal wetting that is added may be different in different steps. Preferably, if the internal wetting agent is added to one or more steps of the process, the same internal wetting agent is added to said one or more steps.

Oxygen permeability (Dk) may be determined by the polarographic method generally described in ISO 9913-1: 1996(E), but with the following variations. The measurement is conducted at an environment containing 2.1% oxygen. This environment is created by equipping the test chamber with nitrogen and air inputs set at the appropriate ratio, for example 1800 ml/min of nitrogen and 200 ml/min of air. The t/Dk is calculated using the adjusted oxygen concentration. Borate buffered saline was used. The dark current is measured by using a pure humidified nitrogen environment instead of applying MMA lenses. The lenses are not blotted before measuring. Four lenses are stacked instead of using lenses of varied thickness. A curved sensor is used in place of a flat sensor. The resulting Dk value is reported in barrers.

The dynamic contact angle or DCA, may be determined at 23±3° C., and a relative humidity of 45±5% using borate buffered saline and a Wilhelmy balance. The wetting force between the lens surface and borate buffered saline is measured using a Wilhelmy microbalance while the sample strip cut from the center portion of the lens is being immersed into or pulled out of the saline at a rate of 100 microns/sec. The following equation is used

F=2γp cos θ or θ=cos⁻¹(F/2γp)

where F is the wetting force, γ is the surface tension of the probe liquid, p is the perimeter of the sample at the meniscus and θ is the contact angle. Typically, two contact angles are obtained from a dynamic wetting experiment—advancing contact angle and receding contact angle. Advancing contact angle is obtained from the portion of the wetting experiment where the sample is being immersed into the probe liquid, and these are the values reported herein. At least four lenses of each composition are measured and the average is reported. It is preferred that the processes of the invention produce ophthalmic devices that have a wettability of less than about 89.

DSC experiments were carried out on a TA Instrument Model DSCQ100-1040 measuring heat flow into or out of the binding copolymer as a function of temperature and the following parameters;

Heat flow selection: Heat flow T4 (mW)

Cooler Type—RCS

Starting Temperature—25° C.

Heating Rate—10.000° C.

Upper Temperature—200.00° C.

Cooling Rate—10.000° C.

Lower Temperature—−70.000° C.

DSC Heat/Cool/Heat was performed to erase the previous thermal history then cooled at a linear rate before heating again. This was based on the ASTM methods E793-85 and D3417-83.

DSC method is as follows:

1) Equilibration at 25° C.

2) Ramp 10.000° C./min to 200.00° C.

3) Mark end of cycle 0.

4) Ramp 10.000° C./min to −70.000° C.

5) Mark end of cycle 0.

6) Ramp 10.000° C./min to 200.00° C.

7) Mark end of cycle 0.
Advanced Parameters: Data sampling interval 0.20 s/pt
Mass Flow: N₂ with a flow rate of 50 ml/min

In order to illustrate the invention the following examples are included. These examples do not limit the invention. They are meant only to suggest a method of practicing the invention. Those knowledgeable in contact lenses as well as other specialties may find other methods of practicing the invention. However, those methods are deemed to be within the scope of this invention.

### EXAMPLES

The following abbreviations were used in the examples
PVP=polyvinylpyrrolidinone;
HEMA=hydroxyethyl methacrylate
AMBN=2,2′-Azobis(2-methylbutyronitrile)
AIBN=2,2′-Azobisisobutyronitrile
DMA=N,N-dimethylacrylamide
EtOH=ethanol
Blue HEMA=the reaction product of reactive blue number 4 and HEMA as described in Example 4 of U.S. Pat. No. 5,944,853
Norbloc=2-(2′-hydroxy-5-methacrylyloxyethylphenyl)-2H-benzotriazole
THF=tetrahydrofuran
OH-mPDMS=mono-(3-methacryloxy-2-hydroxypropyloxy)propyl terminated, mono-butyl terminated polydimethylsiloxane
   The following solutions were used in Examples 29 and 30:

### TLF Solution:

Tear-like fluid buffer solution (TLF Buffer) was prepared by adding the 0.137 g sodium bicarbonate (Sigma, S8875) and 0.01 g D-glucose (Sigma, G5400) to phosphate buffered saline containing calcium and magnesium (Sigma, D8662). The TLF buffer was stirred at room temperature until the components were completely dissolved (approximately 5 min).

A lipid stock solution was prepared by mixing the following lipids in TLF Buffer, with thorough stirring, for about 1 hour at about 60° C., until clear:

| | |
|---|---|
| Cholesteryl linoleate (Sigma, C0289) | 24 mg/mL |
| Linalyl acetate (Sigma, L2807) | 20 mg/mL |
| Triolein (Sigma, 7140) | 16 mg/mL |
| Oleic acid propyl ester (Sigma, O9625) | 12 mg/mL |
| undecylenic acid (Sigma, U8502) | 3 mg/mL |
| Cholesterol (Sigma, C8667) | 1.6 mg/mL |

The lipid stock solution (0.1 mL) was mixed with 0.015 g mucin (mucins from Bovine submaxillary glands (Sigma, M3895, Type 1-S)). Three 1 mL portions of TLF Buffer were added to the lipid mucin mixture. The solution was stirred until all components were in solution (about 1 hour). TLF Buffer was added Q.S. to 100 mL and mixed thoroughly.

The following components were added one at a time, and in the order listed, to the 100 mL of lipid-mucin mixture prepared above. Total addition time was about 1 hour.

| | |
|---|---|
| acid glycoprotein from Bovine plasma (Sigma, G3643) | 0.05 mg/mL |
| Fetal Bovine serum (Sigma, F2442) | 0.1% |
| Gamma Globulins from Bovine plasma (Sigma, G7516) | 0.3 mg/mL |
| β lactoglobulin (bovine milk lipocaline) (Sigma, L3908) | 1.3 mg/mL |
| Lysozyme from Chicken egg white (Sigma, L7651) | 2 mg/mL |
| Lactoferrin from Bovine colostrums (Sigma, L4765) | 2 mg/mL |

The resulting solution was allowed to stand overnight at 4° C. The pH was adjusted to 7.4 with 1 N HCl. The solution was filtered and stored at −20° C. prior to use.

### Lipocalin Solution

Milk lipocalin (β lactoglobulin) from bovine milk (Sigma, L3908) (2 mg/ml) was added to TLF buffer solution and stirred without application of heat until completely dissolved into solution (total time about 30 min).

### Mucin Solution

Mucins from bovine sub-maxillary glands (Sigma, M3895, Type 1-S) (2 mg/ml) was added to TLF buffer solution and stirred without application of heat until completely dissolved into solution (total time about 2 hours).

### Example 1

### Milling Pigments With a Polymer

A solution of PVP K30 was prepared by dissolving 27.9 g PVP K30 (BASF) in 108.5 g of 1-ethoxy-2-propanol. Dissolution occurred on an orbital shaker (100 rpm) over night at room temperature. The solution was then blended with 100 g black pigments (Sicovit Schwartz 85 E172 from BASF, CAS #: 12227-89-3, Chemical Formula FeO.Fe₂O₃, MW 231.54) using a glass spatula. Subsequent pre-mixing was done on a Heidolph mixer equipped with a 40 mm dispersing disc for 2×10 min. Eiger milling was next performed initially for 10 min at 3500 rpm and then for 30 min at 4000 rpm. The cooling water in the Eiger mill was adjusted to reach an equilibrium temperature of 60° C. in both cases. Subsequently, a sample was removed and no particles larger than 10 micron were measured on a grindometer test. (“ASTM D 1316 Standard Test Method for Fineness of Grind of Printing Inks by the NPIRI)

### Example 2

### Measuring the Solids Content of a Viscous Solution

The tare weight of one glass Petri dish was determined on an analytical balance. Approximately 2 grams (Weight A) of the milled composition from Example 1 was placed on the dish, and the dish were placed in a vacuum oven and heated to 150° C. for a minimum of 40 hrs. The weight of the dish (Weight B) was re-determined in order to establish the weight loss. The solids content of the milled composition from Example 1 was found to be using the following formula [(Weight B minus Tare)/Weight A]×100% or 55.1% w/w, and as represented in the Table 1, below.

| | sample 1 | sample 2 |
|---|---|---|
| weight B | 28,0315 | 27,9283 |
| Tare | 26,8575 | 26,8423 |
| Difference | 1,174 | 1,086 |
| weight A | 2,100 | 2,000 |
| Results | 55.90% | 54.30% |

| | |
|---|---|
| Average: | 55.10% |

### Example 3

### Preparation of “Binding Co-Polymer”

A 100 mL beaker was charged with 0.462 g AMBN, 54 g heptane, 18 g ethanol and a magnetic stirring bar. The mixture was stirred until all the AMBN was dissolved, approximately 0.5 hr.

A 500 mL glass reactor equipped with 3 openings was charged with the following: 7.0 g DMA, 0.024 g blue HEMA, 0.462 g AMBN and a magnetic stirring bar. The mixture was stirred until all a solution was obtained, approximately 15 minutes.

A 150 mL beaker was charged with 25.4 g DMA, 2.64 g norbloc and a magnetic stirring bar. The mixture was stirred until all a solution was obtained, approximately 15 minutes. Upon dissolution of components 13.8 g HEMA, and 71.2 g OH-mPDMS was added to the beaker and mixed briefly. 9.0 g of this mixture was transferred to the 500 mL glass reactor along with 42 g ethanol and 126 g heptane.

The 3 openings of the reactor were equipped with the following:

a rubber stopper

a reflux condenser

a stopper with holes that allow 2 silicone tubes to enter the reactor.

While maintaining stirring, the temperature of the reactor was subsequently increased to the boiling point of the mixture. The temperature was noted to be about 70° C.

Reservoirs 1 and 2 of a Watson-Marlow pump were charged with the content of the above-mentioned 100 mL beaker and the remaining part of the liquid in the above-mentioned 150 mL beaker, respectively. The pump was connected to the 2 silicone tubes that enter the reactor with, and the pump speed was adjusted so that the two mixtures were added steadily over a period of 4 hours. After addition completion, the stopper containing the two silicone tubes was replaced with a rubber stopper and the reaction was continued over night under reflux conditions.

Subsequently, the reaction flask was removed from the heat source, and a sample was analyzed for solids content (33%) as described in Example 2, molecular weight (Mₙ=29 kD, M_{w}=56 kD measured in poly(styrene) units) as described in Example 4 and viscosity (50 cPs) as described in Example 5.

### Example 4

### Measuring Molecular Weight of “Binding Co-Polymer”

1 gram of the binding co-polymer solution of Example 3 was diluted with THF in order to reach a binding co-polymer solution concentration of 20 mg/g. A chromatographic set-up consisting of 2 columns from Polymerlab (Mixed C and Mixed D) was used together with THF as the eluent. Narrow poly(styrene) standards purchased from Polymerlab were used to form the calibration curve. The following values were determined for the binding co-polymer of Example 3: Mₙ=29 kD, M_{w}=56 kD measured in poly(styrene) units.

### Example 5

### Measuring Viscosity of a Viscous Solution

5 grams of the binding co-polymer solution of Example 3 was transferred to an aluminium cup and placed in a Brookfield viscosimeter equipped with a S82 spindle. When rotating at 100 rpm the viscosity was measured to be 50 cPs at 23° C.

### Example 6

### Preparation of Clear and Pigmented Inks

A 1 L round bottom flask was charged with 300 g grams of the binding co-polymer solution of Example 3, and 150 g 1-ethoxy-2-propanol was added. The flask was weighed (Weight C) and then mounted on a rotavap having the following settings

Water bath temperature: 85° C.,

Vacuum setting: 30 mbar

The binding co-polymer solution and 1-ethoxy-2-propanol were left on the rotovap. After approximately one hour, the flask was removed from the rotovap and weighed (Weight D). The weight loss of the flask indicated that a solids content of about 40% was reached, as seen in the Table 2, below

TABLE 2

| | |
|---|---|
| Tare weight (empty flask) | 454.13 g |
| Ex 3 Binding co-polymer solution | 300 g (33% solids) |
| Gross weight before rotovap | 904.13 g (Weight C) |
| Gross weight after rotovap | 704.63 g (Weight D) |
| Calculated solids content | 33% * 300 g/ |
| | (Weight D − Tare) = 40% |

(solids content is equivalent to Weight D divided by Weight C multiplied by 100%) to dissolve in the mixture. Dissolution took approximately one hour during which the viscous solution was allowed to cool to room temperature.

The viscous solution was then divided in order to obtain both a clear portion and to prepare a pigmented ink. 100 g of the viscous solution was milled with 55.5 g black pigments (Sicovit Schwartz 85 E172 from BASF) using the methodology described in Example 1. The result was a black ink with the following properties
A solids content of 63.5% w/w (as measured per example 2)
A viscosity of 1600 cP (see example 5)
   The rest was used directly as a clear ink with the following properties
A solids content of 43.2% w/w (as measured per example 2)
A viscosity of 1700 cP (see example 5)

### Example 7

### Pad Printing on Concave Mold Parts

The cups of a Tosh pad printer (Model Logical mi.micro 2EA) were filled with 20 g of the clear ink and 20 g of the black ink from Example 6. A conical silicone pad and cliché with a 12 micron etching were used to print both patterns onto a concave plastic mold. The first clear layer was printed with a full circle cliché and the second pigmented layer was a ring type pattern. Between pickup and printing the silicone pad was exposed to a stream of dry air (circa 22 C, 40% relative humidity) for 0.5 sec.

### Example 8

### Preparation of a Tinted Lens

The following action took place under a blanket of dry nitrogen. Both concave and convex mold parts were stored over night in dry nitrogen prior to use. The concave mold part from Example 7 was charged with 50 mg of reactive mixture. A convex mold part was placed on top of the dosed reactive mixture shown in Table 3, and the closed assembly was placed in a curing box with a controlled temperature (70° C.) and light intensity (1 mW/cm²) for about 0.5 hour.

TABLE 3

| | wt. % |
|---|---|
| Monomers | |
| HO-mPDMS | 55 |
| TEGDMA | 3 |
| DMA | 19.53 |
| HEMA | 8 |
| PVP K-90 | 12 |
| CGI 819 | 0.25 |
| Norbloc | 2.2 |
| Blue HEMA | 0.02 |
| Diluent | |
| TPME | 55 |
| 1-Decanoic acid | 45 |

monomer/diluent ratio 55:45

The closed assembly was demolded and subsequently, the cured lens was removed from the mold parts by immersing the concave curve in DI water≧90° C. The lens was removed from the hot water and noted to have a black pattern on it similar to that of the cliché. The black pattern was not removed by digitally rubbing the lens.

### Example 9

### Preparation of Non-Crosslinked Binding Co-Polymer With an Internal Wetting Agent

A 100 mL beaker was charged with 0.4656 g AMBN, 72 g ethanol and a magnetic stirring bar and stirred for about 0.5 hr to fully dissolve the AMBN.

A 500 mL glass reactor equipped with 3 openings was charged with the following: 8.2 g DMA, 0.024 g blue HEMA, 0.4592 g AMBN and a magnetic stirring bar and stirred for about 15 minutes to fully dissolve the blue HEMA and AMBN in DMA. The mixture was then diluted with 168 g ethanol and 14.4 g PVP K30 was slowly added and the mixture stirred for about 0.25 hr to fully dissolve the PVP powder.

A 150 mL beaker was charged with 24.34 g DMA, 2.641 g norbloc and a magnetic stirring bar and stirred for approximately 0.25 hr to fully dissolve the norbloc in DMA. Next was added 13.88 g HEMA and 71.2 g OH-mPDMS and the mixture stirred briefly. 9.1 g of this mixture was transferred to the 500 mL glass reactor.

The 3 openings of the 500 mL glass reactor were equipped with the following

A rubber stopper

A reflux condenser

A stopper with holes that allow 2 silicone tubes to enter the reactor

While maintaining stirring, the temperature of the reactor was subsequently increased to the boiling point of the mixture, and the temperature was noted to be about 79° C.

Reservoirs 1 and 2 of a Watson-Marlow pump were charged with the contents of the above-mentioned 100 mL beaker and the remaining contents of the above-mentioned 150 mL beaker, respectively. The pump was connected to the glass reactor via the 2 silicone tubes, and the pump speed was adjusted so that the 2 mixtures were added steadily over a period of 4 hours. After addition completion, the stopper containing the two silicone tubes were replaced with a rubber stopper and the reaction was allowed to continue over night under reflux conditions.

### Example 10

### Preparation of Non-Crosslinked Binding Copolymer Without Additional Additives

A binding polymer was made from the components listed in Table 4. A 250 ml Erlenmeyer flask (1) was charged with 0.125 g of AIBN, 67 ml EtOH and stirred until dissolved. The Erlenmeyer was then sealed and purged for at least 10 minutes with N₂.

A 1 L three neck jacketed flask was equipped with a reflux condenser, a mechanical stirrer, and a rubber stopper with two openings (for tubing to be connected to a pump). To the 1 L three neck jacketed reactor was added 67 ml EtOH, 2.77 g DMA and 0.125 g AIBN. The mixture was stirred until dissolved.

A 250 ml beaker was charged with 9.84 g DMA, 6.87 g HEMA, and 30.72 g OH-mPDMS and stirred for 5 minutes to form a homogenous solution. 4.48 g of this monomer mixture was transferred to the 1 L jacketed reactor. The reactor was purged with N₂ for 45 minutes.

The remaining monomer mixture in the 250 ml beaker, was added to a second 250 ml Erlenmeyer flask (2). The 250 ml beaker was rinsed with 1×15 ml and the rinsate was transferred to the Erlenmeyer (2). The final volume of Erlenmeyer (2) was adjusted to 67 ml. The flask was then sealed and purged with N₂ for at least 10 minutes.

Erlenmeyer flasks (1) and (2) were connected to the 1 L reaction flask via a Watson-Marlow pump (effectively becoming the two reservoirs on the pump and attached via the tubing connection through the rubber stopper). The temperature of the reaction mixture was increased to 70° C. and began stirring for 18 hours. The reaction was put under a continuous flow of N₂ throughout the reaction. Next, the speed of the pump was adjusted so that the contents of Erlenmeyer (1) and (2) were added to the reactor steadily over a period of 4 hours. After 4 hours, the rubber stopper was removed and replaced with a glass stopper. The reaction was then allowed to finish overnight under reflux conditions.

After 18 hours, 5 g of material was extracted and concentrated down by rotary evaporation (about 60 minutes, 50° C. water bath, under vacuum). The resulting binding polymer was then dried under in a vacuum oven at 50° C. for 72 hours before performing DSC experiments. The Tg is reported in Table 4.

### Examples 11-15

### Preparation of Non-Crosslinked Binding Copolymers Without Additional Additives

Example 10 was repeated except that the total amounts of the components were varied to produce non-crosslinked binding copolymers having different Tg values. Table 4 lists the total amounts of components used in Examples 11-15. The concentrations of components added to the 1 L jacketed flask, the 250 ml beaker, the amounts transferred from the 250 ml beaker to the jacketed flask and the remaining amount in the 250 ml beaker that is transferred to Erlenmeyer flask (2) were adjusted to form the desired non-crosslinked binding copolymers. Table 5 lists the amounts charged to the 1 L jacketed flask. Table 6 lists the amounts in the 250 ml beaker and the amounts transferred from the 250 ml beaker. The remaining amount in the 250 ml beaker was transferred to the Erlenmeyer flask (2).

After 18 hours, 5 g of material was extracted and concentrated down by rotary evaporation (about 60 minutes, 50° C. water bath, under vacuum). The resulting binding polymer was then dried under in a vacuum oven at 50° C. for 72 hours before performing DSC experiments. The Tg is reported in Table 4.

TABLE 4

| | WT % component | | | | |
|---|---|---|---|---|---|
| EX # | [OH-mPDMS] | [DMA] | [HEMA] | [AlBN] | Tg (° C.) |
| 10 | 60.5 | 25 | 14 | 0.5 | 39 |
| 11 | 50.5 | 25 | 24 | 0.5 | 44 |
| 12 | 45.5 | 25 | 29 | 0.5 | 68 |
| 13 | 40.5 | 25 | 34 | 0.5 | 69 |
| 14 | 36 | 26 | 37.5 | 0.5 | 78 |
| 15 | 26 | 26 | 47.5 | 0.5 | 82 |

TABLE 5
1 L Jacketed Reactor

| Ex # | [DMA] (g) | [AIBN] (g) | Volume (ml) |
|---|---|---|---|
| 10 | 2.78 | 0.125 | 67 |
| 11 | 2.84 | 0.125 | 67 |
| 12 | 2.84 | 0.125 | 67 |
| 13 | 2.84 | 0.125 | 67 |
| 14 | 2.78 | 0.125 | 67 |
| 15 | 2.78 | 0.125 | 67 |

TABLE 6
250 mL beaker

| | [OH-mPDMS] | | [HEMA] | Amount added |
|---|---|---|---|---|
| Ex # | (g) | [DMA] (g) | (g) | to reactor (g) |
| 10 | 30.27 | 9.84 | 6.87 | 4.48 |
| 11 | 24.02 | 9.21 | 11.50 | 4.03 |
| 12 | 22.77 | 9.84 | 14.37 | 4.48 |
| 13 | 20.27 | 9.84 | 16.87 | 4.48 |
| 14 | 18.09 | 10.08 | 18.74 | 4.22 |
| 15 | 13.09 | 10.08 | 23.73 | 4.22 |

### Example 16

### Preparation of Colorant Formulation Containing Non-Crosslinked Binding Copolymer and Blue HEMA as a Dye

A non-crosslinked binding copolymer was made from the components listed in Table 7. A 1 L Erlenmeyer flask (1) was charged with 0.375 g of AIBN, 200 ml EtOH and stirred until dissolved. The Erlenmeyer (1) was then sealed and purged for at least 45 minutes with N₂.

A 3 L three neck jacketed flask was equipped with a reflux condenser, a mechanical stirrer, and a rubber stopper with two openings (for tubing to be connected to a pump). To the 3 L three neck jacketed reactor was added 200 ml EtOH, 8.75 g DMA, 18 g PVP (K30) and 0.375 g AIBN. The mixture was stirred until dissolved.

A 1 L beaker was charged with 18.23 g DMA, 12 g HEMA, 3.4 g Norbloc, 8 g Blue HEMA, 81 g OH-mPDMS and stirred until a homogenous solution was formed. 9.5 g of this monomer mixture was transferred to the 3 L jacketed reactor. The reactor was purged with N₂ for 45 minutes.

The remaining monomer mixture, in the 1 L beaker, was added to a second 1 L Erlenmeyer flask (2). The 1 L beaker was rinsed with 2×30 ml and the rinsate was transferred to the Erlenmeyer (2). The final volume of Erlenmeyer (2) was adjusted to 200 ml. The flask was then sealed and purged with N₂ for at least 45 minutes.

Erlenmeyer flasks (1) and (2) were connected to the 3 L reaction flask via a Watson-Marlow pump (effectively becoming the two reservoirs on the pump and attached via the tubing connection through the rubber stopper). The temperature of the reaction mixture was increased to 70° C. and began stirring for 18 hours. The reaction was put under a continuous flow of N₂ throughout the reaction. Next, the speed of the pump was adjusted so that the contents of Erlenmeyer (1) and (2) were added to the reactor steadily over a period of 4 hours. After 4 hours, the rubber stopper was removed and replaced with a glass stopper. The reaction was then allowed to finish overnight under reflux conditions.

The reaction mixture was next transferred to a 2 L round bottom flask and the solvent was distilled off by rotary evaporation (50° C., under vacuum, about 2 hours). Approximately 100 ml of a 50:50 solution of 1-ethoxy-2-propanol and ethanol was added back to the round bottom and stirred and the solution was transferred to a 1 L amber jar. The jar is rolled and a 50:50 solution of 1-ethoxy-2-propanol and ethanol was added until a viscosity of 1000 cps was achieved using a Brookfield digital viscometer (spindle number 18, 1.5 rpm at 25° C.).

### Examples 17-19

Example 16 was repeated except that the total amounts of the components, the amounts in 3 L jacketed flask, the amounts in the 1 L beaker, the amounts transferred from the 1 L beaker to the jacketed flask and the remaining amount in the 1 L beaker that is transferred to 1 L Erlenmeyer flask (2) are different. Table 7 lists the total amounts of components. Table 8 lists the amounts charged to the 3 L jacketed flask. Table 9 lists the amounts in the 1 L beaker and the amounts transferred from the 1 L beaker. The remaining amount in the 1 L beaker was transferred to the 1 L Erlenmeyer flask (2).

TABLE 7
Total Amounts of Components

| | Wt % component | | | | | | |
|---|---|---|---|---|---|---|---|
| EX | [OH- | | | | [BLUE | | [PVP |
| # | Mpdms] | [DMA] | [HEMA] | [Norbloc] | HEMA] | [AlBN] | K30] |
| 16 | 54 | 18 | 8 | 2.3 | 5.3 | 0.50 | 12 |
| 17 | 44 | 20.5 | 19 | 2.3 | 2 | 0.50 | 12 |
| 18 | 21 | 21 | 42 | NA | 3.4 | 0.50 | 12 |
| 19 | 30.5 | 20 | 34 | NA | 3.3 | 0.50 | 12 |

TABLE 8
3 L Jacketed Reactor

| | | | [PVP K30] |
|---|---|---|---|
| EX # | [DMA] (g) | [AIBN] (g) | (g) |
| 16 | 8.75 | 0.375 | 18 |
| 17 | 6.75 | 0.375 | 18 |
| 18 | 6.75 | 0.375 | 18 |
| 19 | 7 | 0.375 | 18 |

TABLE 9
1L Beaker

| | [OH- | | | | [BLUE | Amount |
|---|---|---|---|---|---|---|
| EX | mPDMS] | [DMA] | [HEMA] | [Norbloc] | HEMA] | added to 3L |
| # | (g) | (g) | (g) | (g) | (g) | reactor (g) |
| 16 | 81 | 18.23 | 12 | 3.4 | 8 | 9.5 |
| 17 | 66.5 | 24 | 28.5 | 3.4 | 3 | 9.5 |
| 18 | 46 | 24 | 51 | 0 | 5 | 9.9 |
| 19 | 31 | 7 | 61.5 | 0 | 5 | 9.9 |

### Example 20

### Colorless Coating Composition

A binding polymer was made from the components listed in Table 7. A 1 L Erlenmeyer flask (1) was charged with 1.125 g of AIBN, 600 ml EtOH and stirred until dissolved. The Erlenmeyer (1) was then sealed and purged for at least 45 minutes with N₂.

A 3 L three neck jacketed flask was equipped with a reflux condenser, a mechanical stirrer, and a rubber stopper with two openings (for tubing to be connected to a pump). To the 3 L three neck jacketed reactor was added 600 ml EtOH, 20.25 g DMA, 54 g PVP (K30) and 1.125 g AIBN. The mixture was stirred until dissolved.

A 1 L beaker was charged with 72 g DMA, 40.5 g HEMA, 10.13 g Norbloc, and 251.25 g OH-mPDMS and stirred until a homogenous solution was formed. 29.45 g of this monomer mixture was transferred to the 3 L jacketed reactor. The reactor was purged with N₂ for 45 minutes.

The remaining monomer mixture, in the 1 L beaker, was added to a second 1 L Erlenmeyer flask (2). The 1 L beaker was rinsed with 2×30 ml and the rinsate was transferred to the Erlenmeyer (2). The final volume of Erlenmeyer (2) was adjusted to 600 ml. The flask was then sealed and purged with N₂ for at least 45 minutes.

Erlenmeyer flasks (1) and (2) were connected to the 3 L reaction flask via a Watson-Marlow pump (effectively becoming the two reservoirs on the pump and attached via the tubing connection through the rubber stopper). The temperature of the reaction mixture was increased to 70° C. and began stirring for 18 hours. The reaction was put under a continuous flow of N₂ throughout the reaction. Next, the speed of the pump was adjusted so that the contents of Erlenmeyer (1) and (2) were added to the reactor steadily over a period of 4 hours. After 4 hours, the rubber stopper was removed and replaced with a glass stopper. The reaction was then allowed to finish overnight under reflux conditions. The reaction mixture was next transferred (in two batches) to a 2 L round bottom flask and the solvent was distilled off by rotary evaporation (50° C., under vacuum, about 2 hours).

A colorless coating composition was formed by adding approximately 200 ml of a 50:50 solution of 1-ethoxy-2-propanol and ethanol back to the round bottom flask and stirred and solution transferred to a 2 L amber jar. The jar was rolled and a 50:50 solution of 1-ethoxy-2-propanol and ethanol was added until a viscosity of 1000 cps was achieved using a Brookfield digital viscometer (spindle number 18, 1.5 rpm at 25° C.).

### Examples 21-24

### Lens Fabrication

Clear coat composition as made in example 20 was pad printed onto a concave mold. The colorant compositions of Examples 16-19 were pad printed onto the concave mold for examples 21-24, respectively.

These pad printed concave mold parts and the non-printed convex mold parts were stored over night in 2.8% oxygen prior to further use.

Under a blanket of dry nitrogen containing 2.8% oxygen, the concave mold part was charged with 70 mg of the reactive mixture disclosed in Table 3. A convex mold part was placed on top of the dosed reactive monomer mix, and the closed assembly was subjected to precure weights (˜200 grams) to ensure proper mold closure. The closed, weighted assemblies were placed in a precure tunnel at 50° C. for 4 min with no lights. The precure weights were removed and the assemblies were placed in a curing tunnel with a controlled temperature of 70° C. and light intensity of 1.5 mW/cm² for about 4 minutes then 7.0 mW/cm² for an additional 4 minutes.

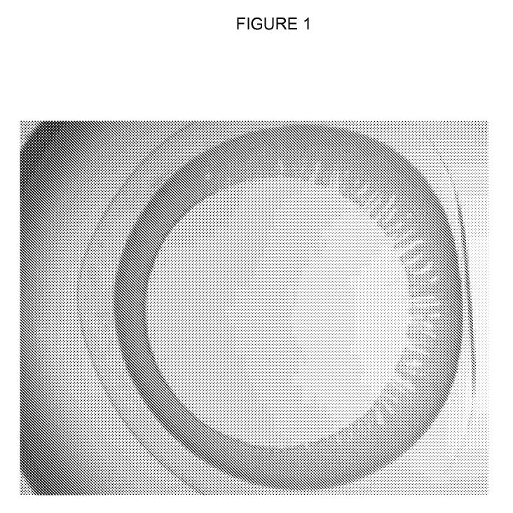

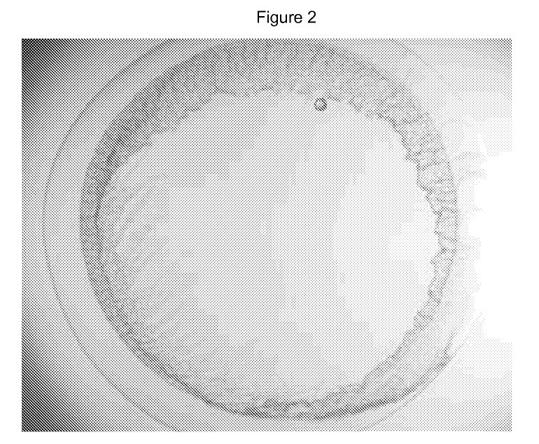

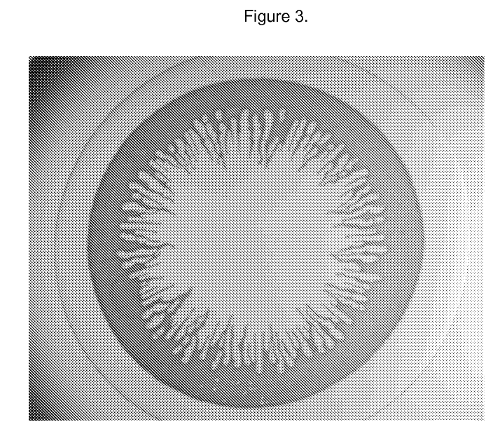

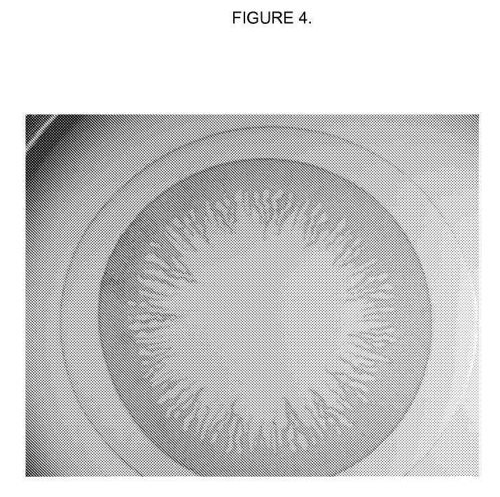

The closed assembly was demolded and subsequently, the cured lenses were removed from the mold parts by immersing the concave curve in 2° C. DI water (20 min) then 90° C. packing solution (60 min). The lenses were removed from the 90° C. packing solution, and noted to have a pattern similar to that of the cliche. Smear was assessed by digital rub of the lenses (those that do not smear do not rub off the lenses) and by visual observation (Table 10). Representative photographs of the observations are shown in FIGS. 1-4.

TABLE 10
Smear Assessment

| Colorless | Colorant | | Lens Fabrication | |
|---|---|---|---|---|
| Coating | Composition | Lens Fabrication | (wo/precure) | |
| Ex # | Ex # | (w/precure) Ex # | Ex # | Smear |
| 20 | 16 | 21 | 25 | Yes |
| 20 | 17 | 22 | 26 | Yes |
| 20 | 18 | 23 | 27 | No |
| 20 | 19 | 24 | 28 | No |

### Examples 25-28

Examples 21-24 were repeated except that closed, weighted assemblies were placed directly into the cure tunnel, instead of in a procure tunnel at 50° C. for 4 minutes with no lights. After cure, the closed assemblies were demolded and the cured lenses were removed from the mold parts as described in Examples 21-24. The lenses were removed from the hot water and noted to have a pattern on it similar to that of the cliché. Smear was assessed by digital rub of the lenses (those that do not smear do not rub off the lenses) and by visual observation (Table 10).

### Example 29

### Preparation of Non-Crosslinked Binding Polymer Compositions and Lenses With 1E2P as Solvent

A 1 L Erlenmeyer flask (1) was charged with 0.300 g of AIBN, 400 ml EtOH and stirred until dissolved. The Erlenmeyer (1) was then sealed and purged for at least 45 minutes with N₂.

A 3 L three neck jacketed flask was equipped with a reflux condenser, a mechanical stirrer, and a rubber stopper with two openings (for tubing to be connected to a pump). To the 3 L three neck jacketed reactor was added 400 ml EtOH, 14 g DMA, 32.25 g PVP (K90) and 0.07 g AIBN. The mixture was stirred until dissolved.

A 1 L beaker was charged with 50.8 g DMA, 27.6 g HEMA, 5.3 g Norbloc, 142.2 g OH-mPDMS and stirred until a homogenous solution was formed. 18 g of this monomer mixture was transferred to the 3 L jacketed reactor. The reactor was purged with N₂ for 45 minutes.

The remaining monomer mixture, in the 1 L beaker, was added to a second 1 L Erlenmeyer flask (2). The 1 L beaker was rinsed with 2×30 ml and the rinsate was transferred to the Erlenmeyer (2). The final volume of Erlenmeyer (2) was adjusted to 400 ml. The flask was then sealed and purged with N₂ for at least 45 minutes.

Erlenmeyer flasks (1) and (2) were connected to the 3 L reaction flask via a Watson-Marlow pump (effectively becoming the two reservoirs on the pump and attached via the tubing connection through the rubber stopper). The temperature of the reaction mixture was increased to 70° C. and began stirring for 18 hours. The reaction was put under a continuous flow of N₂ throughout the reaction. Next, the speed of the pump was adjusted so that the contents of Erlenmeyer (1) and (2) were added to the reactor steadily over a period of 4 hours. After 4 hours, the rubber stopper was removed and replaced with a glass stopper. The reaction was then allowed to finish overnight under reflux conditions.

The reaction mixture was next transferred to a 2 L round bottom flask and the solvent was distilled off by rotary evaporation (50° C., under vacuum, about 2 hours). Approximately 200 ml of 1-ethoxy-2-propanol was added back to the round bottom and stirred and solution transferred to a 1 L amber jar. The jar was rolled and 1-ethoxy-2-propanol was added until a viscosity of 1000 cps was achieved using a Brookfield digital viscometer (spindle number 18, 1.5 rpm at 25° C.).

Contact lenses were made from this colorless coating composition as in Example 21, except that no colorant composition was used in lens fabrication. Protein, mucin, and lipocalin uptake was measured as follows.

The lenses (six replicates of each test lens) were blotted to remove packing solution and aseptically transferred, using sterile forceps, into 24 Well Cell Culture Cluster (one lens per well). Each well contained 1 ml of TLF and each lens was fully submerged in the solution. The cell culture tray is parafilmed to prevent loss of solution via splashing or evaporation.

The lenses were incubated in 1 ml of TLF at 35° C. with rotative agitation (100 rpm) for 72 hours. The TLF solution was changed every 24 hours. At the end of the incubation period, protein uptake was measured after rinsing the test lenses three times in three separate vials containing phosphate buffered saline solution.

Protein uptake was carried out using a bicinchroninic acid method (QQP-BCA kit, Sigma) following the description provided by the manufacturer. A standard curve is prepared using the albumin solution provided with the QP-BCA kit.

24 wells plates are labeled and the albumin standards are prepared by adding the Albumin Stock Solution to PBS, as indicated in Table 11 below:

TABLE 11

| | | Albumin | Final |
|---|---|---|---|
| | PBS | Stock | Conc |
| Tube # | (ul) | Soln (ul) | (ug/ml) |
| 1 | 1000 | 0 | 0 |
| 2 | 990 | 10 | 0.5 |
| 3 | 900 | 100 | 5 |
| 4 | 800 | 200 | 10 |
| 5 | 600 | 400 | 20 |
| 6 | 400 | 600 | 30 |

QP-BCA reagent is prepared fresh by mixing 25 parts of QA reagent with 25 parts of QB reagent and 1 part of QC reagent (Copper(II) sulfate), as indicated in the Sigma QP-BCA kit instruction. Enough reagent was prepared to provide for all control and test lens samples as well as standard samples, whereby an equal volume of QP-BCA reagent was required for each volume of PBS in the sample/standard.

An equal volume of QP-BCA reagent was added to each sample (1 ml for lenses placed in 1 ml PBS).

Standard, lens, and solution samples were incubated at 60° C. for 1 hour, and samples allowed to cool for 5 to 10 minutes. Absorbance of the solution was measured at 562 nm using a spectrophotometer.

The mucin and lipocalin uptake as measured as described for protein uptake, except that 2 ml aliquots of the solution were used instead of 1 ml, and the incubation periods were 1 and 3 days respectively. The results are listed in Table 12.

### Example 30

Example 29 was repeated, except that a 50:50 solution of 1-ethoxy-2-propanol and ethanol was used as the solvent to make the colorless coating composition. Contact lenses were made from this clear coat composition as in Example 21. Protein, mucin, and lipocalin uptake data is listed in Table 12.

TABLE 12

| Ex | Mucin μg/lens | Protein μg/lens | Lipocalin μg/lens |
|---|---|---|---|
| 29 | 5.98 (±0.17) | 12.78 (±0.31) | 7.32 (±0.24) |
| 30 | 5.42 (±0.23) | 11.93 (±0.32) | 6.56 (±0.13) |

### Example 31

### Non-Crosslinked Binding Polymer Compositions With NVP

A 1 L Erlenmeyer flask (1) was charged with 0.300 g of AIBN, 200 ml EtOH and stirred until dissolved. The Erlenmeyer (1) was then sealed and purged for at least 45 minutes with N₂.

A 3 L three neck jacketed flask was equipped with a reflux condenser, a mechanical stirrer, and a rubber stopper with two openings (for tubing to be connected to a pump). To the 3 L three neck jacketed reactor was added 200 ml EtOH, 15.75 g NVP, 5.67 g DMA and 0.300 g AIBN. The mixture was stirred until dissolved.

A 1 L beaker was charged with 20.08 g DMA, 11.80 g HEMA, 15.75 g NVP 50.17 g OH-mPDMS and stirred until a homogenous solution was formed. 12.23 g of this monomer mixture was transferred to the 3 L jacketed reactor. The reactor was purged with N₂ for 45 minutes.

The remaining monomer mixture, in the 1 L beaker, was added to a second 1 L Erlenmeyer flask (2). The 1 L beaker was rinsed with 2×30 ml and the rinsate was transferred to the Erlenmeyer (2). The final volume of Erlenmeyer (2) was adjusted to 200 ml. The flask was then sealed and purged with N₂ for at least 45 minutes.

Erlenmeyer flasks (1) and (2) were connected to the 3 L reaction flask via a Watson-Marlow pump (effectively becoming the two reservoirs on the pump and attached via the tubing connection through the rubber stopper). The temperature of the reaction mixture was increased to 70° C. and began stirring for 18 hours. The reaction was put under a continuous flow of N₂ throughout the reaction. Next, the speed of the pump was adjusted so that the contents of Erlenmeyer (1) and (2) were added to the reactor steadily over a period of 4 hours. After 4 hours, the rubber stopper was removed and replaced with a glass stopper. The reaction was then allowed to finish overnight under reflux conditions.

The reaction mixture was next transferred to a 2 L round bottom flask and the solvent was distilled off by rotary evaporation (50° C., under vacuum, about 2 hours). Approximately 100 ml of a 50:50 solution of 1-ethoxy-2-propanol and ethanol was added back to the round bottom and stirred and solution transferred to a 1 L amber jar. The jar was rolled and a 50:50 solution of 1-ethoxy-2-propanol and ethanol was added until a viscosity of 1000 cps was achieved using a Brookfield digital viscometer (spindle number 18, 1.5 rpm at 25° C.).

What is claimed is:

1. A process comprising
(a) applying a first colorant composition comprising at least one non-crosslinked binding co-polymer, at least one pigment, dye or mixture thereof and at least one printing solvent to a surface of an ophthalmic device mold;
(b) adding up to an amount required to prepare an ophthalmic device, and over the non-crosslinked binding co-polymer of step (b), an uncured hydrogel formulation, wherein said hydrogel formulation, when cured, has a oxygen permeability of greater than about 50 barrer; and
(c) curing said hydrogel formulation to form a stable, tinted ophthalmic device.

2. The process of claim 1 wherein the non-crosslinked binding co-polymer comprises at least one oxygen permeability enhancing component.

3. The process of claim 2 wherein said at least one oxygen permeability enhancing component is selected from compounds of Formula I 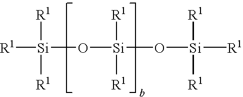
where
R¹ is independently selected from monovalent reactive groups, monovalent alkyl groups, or monovalent aryl groups, any of the foregoing which may further comprise functionality selected from hydroxy, amino, oxa, carboxy, alkyl carboxy, alkoxy, amido, carbamate, carbonate, halogen or combinations thereof; and monovalent siloxane chains comprising 1-100 Si—O repeat units which may further comprise functionality selected from alkyl, hydroxy, amino, oxa, carboxy, alkyl carboxy, alkoxy, amido, carbamate, halogen or combinations thereof;
b=0 to 500, where it is understood that when b is other than 0, b is a distribution having a mode equal to a stated value;
at least one R¹ comprises a monovalent reactive group, and in some embodiments between one and 3 R¹ comprise monovalent reactive groups.

4. The process of claim 2 wherein the oxygen permeability enhancing component comprises 3-methacryloxypropyltris(trimethylsiloxy)silane, monomethacryloxypropyl terminated polydimethylsiloxanes, polydimethylsiloxanes, 3-methacrylxoypropylbis(trimethylsiloxy)methylsilane, methacryloxypropylpentamethyl disiloxane and combinations thereof

5. The process of claim 2 wherein the oxygen permeability enhancing component comprises mono-(3-methacryloxy-2-hydroxypropyloxy)propyl terminated, mono-butyl terminated polydimethylsiloxane.

6. The process of claim 1 wherein the non-crosslinked binding co-polymer comprises a monomer selected from the group consisting of N,N-dimethylacrylamide, 2-hydroxyethyl methacrylamide, 2-hydroxyethyl methacrylate propylethyleneglycol momomethyacrylate, methacrylic acid, acrylic acid, N-vinyl pyrrolidone, N-vinyl-N-methylacetamide, N-vinyl-N-ethyl acetamide, N-vinyl-N-ethyl formamide, n-vinyl formamide and mixtures thereof.

7. The process of claim 1 wherein the non-crosslinked binding co-polymer comprises monomers selected from the group consisting monomers of Formulae of II, IV, VI and VII: 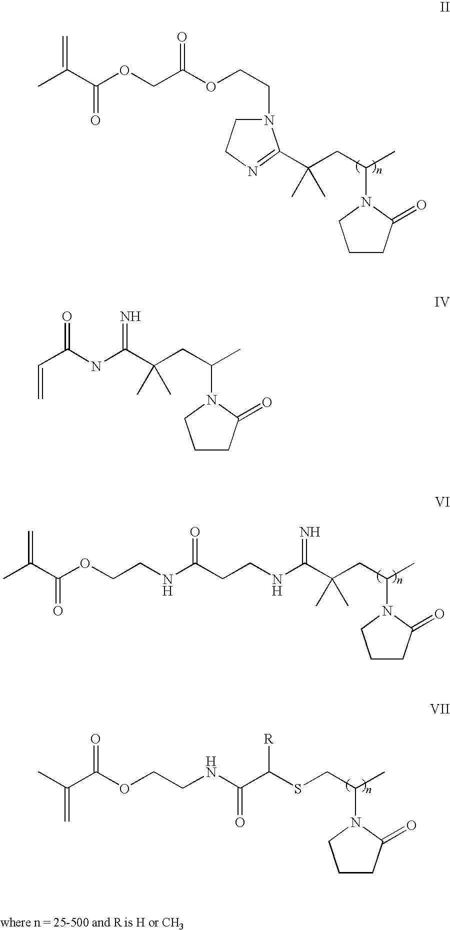
and mixtures thereof.

8. The process of claim 1 wherein the non-crosslinked binding co-polymer comprises monomers selected from the group consisting of hydroxylethyl methacrylamide, N,N-dimethylacrylamide, N-vinyl pyrrolidone and mixtures thereof.

9. The process of claim 1 wherein step (a) is repeated using a second colorant composition.

10. The process of claim 9 wherein second colorant composition is different from said first colorant composition.

11. The process of claim 1 or 10 wherein at least one of the first or second colorant composition comprises at least one internal wetting agent.

12. The process of claim 11 wherein the internal wetting agent comprises polyvinylpyrrolidone having an average molecular weight of about 30 kD to about 1000 kD

13. The process of claim 11 wherein the internal wetting agent is selected from the group consisting of polyvinylpyrrolidone, poly-2-ethyl-2-oxazoline, poly(N,N-dimethylacrylamide), and polyvinyl alcohol.

14. The process of claim 11 wherein the internal wetting agent is polyvinylpyrrolidone.

15. The process of claim 1 wherein said binding polymer has a glass transition temperature of at least about 60° C.

16. The process of claim 1 wherein said binding polymer has a glass transition temperature of at least about 70° C.

17. The process of claim 1 wherein said binding polymer has a glass transition temperature of at least about 75° C.

18. The process of claim 1 wherein said colorant composition further comprises at least one mid-boiling solvent.

19. The process of claim 18 wherein said mid-boiling solvent is selected from the group consisting of 1-ethoxy-2-propanol, 1,2-octanediol, 3-methyl-3-pentanol, 1-pentanol, methyl lactate, 1-methoxy-2-propanol, and mixtures thereof.

20. The process of claim 18 wherein said mid-boiling solvent comprises 1-ethoxy-2-propanol.

21. The process of claim 18 wherein said colorant composition further comprises at least one polar solvent.

22. The process of claim 21 wherein said at least one polar solvent is selected from the group consisting of methanol, ethanol, t-amyl alcohol, propanol, butanol and mixtures thereof.

23. A process comprising:
(a) applying a colorless coating composition comprising at least one non-crosslinked binding co-polymer and at least one printing solvent to at least one surface of an ophthalmic device mold,
(b) applying a first colorant composition comprising at least one non-crosslinked binding co-polymer, at least one pigment, dye or mixture thereof and at least one printing solvent over the colorless coating composition applied in step (a);
(c) adding, up to an amount required to prepare an ophthalmic device, and over the non-crosslinked binding co-polymer of step (b), an uncured hydrogel formulation, wherein said hydrogel formulation, when cured, has a oxygen permeability of greater than about 50 barrer; and
(d) curing said hydrogel formulation to form a stable tinted ophthalmic device.

24. The process of claim 23 wherein step (b) is repeated using a second colorant composition.

25. The process of claim 24 wherein second colorant composition is different from said first colorant composition.

26. The process of claims 123-24 wherein at least one of the colorless coating composition and the first and second coating composition comprises at least one internal wetting agent.

27. The process of claim 26 wherein the internal wetting agent is selected from the group consisting of polyvinylpyrrolidone, poly-2-ethyl-2-oxazoline, poly(N,N-dimethylacrylamide), and polyvinyl alcohol.

28. The process of claim 26 wherein the colorless coating composition and the first coating composition further comprise at least one internal wetting agent, which may be the same or different.

29. The process of claim 26 wherein the colorless coating composition and the first and second coating compositions further comprise at least one internal wetting agent, which may be the same or different.

30. The process of claim 26 wherein the internal wetting agent is polyvinylpyrrolidone.

31. The process of claim 23 wherein said at least one binding polymer has a glass transition temperature of at least about 60° C.

32. The process of claim 23 wherein said at least one binding polymer has a glass transition temperature of at least about 70° C.

33. The process of claim 23 wherein said at least one binding polymer has a glass transition temperature of at least about 75° C.

34. The process of claim 23 wherein said colorant composition further comprises at least one mid-boiling solvent.

35. The process of claim 34 wherein said mid-boiling solvent is selected from the group consisting of 1-ethoxy-2-propanol, 1,2-octanediol, 3-methyl-3-pentanol, 1-pentanol, methyl lactate, 1-methoxy-2-propanol, and mixtures thereof.

36. The process of claim 34 wherein said mid-boiling solvent comprises 1-ethoxy-2-propanol.

37. The process of claim 34 wherein said colorant composition further comprises at least one polar solvent.

38. The process of claim 36 wherein said at least one polar solvent is selected from the group consisting of methanol, ethanol, t-amyl alcohol, propanol, butanol and mixtures thereof.

39. The process of claims 1 or 23 wherein said hydrogel formulation is suitable for ophthalmic use without surface modification.

40. A composition for use in the production of stable tinted hydrogel ophthalmic devices having an oxygen transmissibility of greater than about 50 comprising at least one printing solvent, and at least one pigment, dye or mixture thereof and at least one non-crosslinked binding co-polymer formed from reaction of components comprising at least one oxygen permeable enhancing component.

41. The composition of claim 40 wherein the non-crosslinked binding co-polymer further comprises at least one traditional monomer.

42. The composition of claim 40 further comprising an internal wetting agent.

43. The composition of claim 40 having a viscosity of about 500 cps to about 2500 cps.

44. The composition of claim 41 wherein said at least one traditional monomer is selected from the group consisting of 2-hydroxyethyl methacrylate, hydroxylethyl methacrylamide, N,N-dimethylacrylamide, N-vinylpyrrolidone, and mixtures thereof.

45. The composition of claim 40 wherein said at least one oxygen permeability enhancing component is selected from the group consisting of 3-methacryloxypropyltris(trimethylsiloxy)silane, monomethacryloxypropyl terminated polydimethylsiloxanes, polydimethylsiloxanes, 3-methacrylxoypropylbis(trimethylsiloxy)methylsilane, methacryloxypropylpentamethyl disiloxane, mono-(3-methacryloxy-2-hydroxypropyloxy)propyl terminated, mono-butyl terminated polydimethylsiloxane, and mixtures thereof.

46. The composition of claim 40 wherein said at least one non-crosslinked binding copolymer has a glass transition temperature of at least about 60° C.

47. A stable, tinted hydrogel ophthalmic device comprising a body formed of a silicone hydrogel having an oxygen transmissibility of greater than about 50 barrer/mm comprising at least one non-crosslinked binding co-polymer entangled at or near at least one surface of said silicone hydrogel.

48. The ophthalmic device of claim 47 wherein said non-crosslinked binding co-polymer comprises an internal wetting agent.

49. The ophthalmic device of claim 47 wherein said device is wettable.

50. The ophthalmic device of claim 47 wherein said device has an advancing dynamic contact angle of about 24 to about 90.

51. The ophthalmic device of claim 47 wherein said silicone hydrogel suitable for ophthalmic use without surface modification

52. The ophthalmic device of claim 47 wherein said at least one binding polymer has a glass transition temperature of at least about 60° C.

53. An ophthalmic device formed from the process of any of claims 1-10, 15-25 and 30-38.

54. The ophthalmic device of claim 53, wherein at least one of the colorless composition, the first or second coating composition comprises at least one internal wetting agent.

55. The ophthalmic device of claim 53 wherein the uncured hydrogel formulation is selected from the group consisting of galyfilcon, senofilcon, genfilcon, lenefilcon, comfilcon, acquafilcon, balafilcon, and lotrafilcon, and narafilcon.

56. The process of claim 1 or 23 further comprising the step of treating the mold after applying said colorant composition to at least partially remove volatile components.
